(19) United States
(12) Patent Application Publication
(10) Pub. No.: US 2007/0132893 A1
(43) Pub. Date: Jun. 14, 2007

(54) PROJECTION SYSTEM AND PROJECTOR

(75) Inventors: Yasunaga MIYAZAWA, Suwa-shi, Nagano-ken (JP); Mitsuhiro INAZUMI, Suwa-shi, Nagano-ken (JP); Toshiki FUJIMORI, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/611,013

(22) Filed: Dec. 14, 2006

(30) Foreign Application Priority Data
Dec. 14, 2005 (JP) 2005-360161

(51) Int. Cl. H04N 3/26

(52) U.S. Cl. 348/745

(57) ABSTRACT

A projection system includes an information processing apparatus that processes image information, a projector including a light source, an optical modulation device that modulates light emitted from the light source based on the image information processed by the information processing apparatus and forms an optical image based on the modulated light, and a projection optical apparatus that projects the optical image to form a projection image, and an information transferring unit that interconnects the information processing apparatus and the projector for information exchange between the information processing apparatus and the projector. Here, the projector includes a light detecting part that is disposed at a rear side of an optical path of the optical modulation device, detects at least a portion of the optical image outputted from the optical modulation device, and outputs detection information based on the detected at least portion of the optical image. The information processing apparatus includes: a correction mode transferring part that transfers to a correction mode to correct a color spot correction parameter to correct color spots occurring in the projection image, based on the at least portion of the optical image detected in the light detecting part, while forming the optical image on the optical modulation device; and a parameter correcting part that acquires the detection information outputted from the light detecting part via the information transferring unit and corrects the color spot correction parameter based on the acquired detection information in the correction mode.

### BACKGROUND

1. Technical Field

The present invention relates to a projection system and a projector.

2. Related Art

A projector including a light source, an optical modulating device that modulates light emitted from the light source based on an image information to form an optical image, and an optical projection device that enlarges and projects the optical image has been known in the related art.

When such a projector is used for a long period of time, internal optical elements such as the optical modulating device may be deteriorated due to light irradiation from the light source, which may result in color spots on a projection image projected from the projection device.

As one of methods of preventing color spots from occurring in the projection image with time, the following techniques have been proposed.

JP-A-2005-24855 discloses a technique n which color spot correction data (color spot correction parameters) that have different data values corresponding to elapsed time and are used to correct color spots occurring with temporal change of a liquid crystal panel are stored, the color spot correction data occurring with time are read according to use time of the liquid crystal panel, and a level of a waveform of a driving signal applied to the liquid crystal panel is corrected using the color spot correction data.

In addition, JP-A-2004-228942 discloses a technique in which a calibration image projected on a screen is imaged by an imaging device, the amount of correction for color spots occurring in a projection image is calculated, based on the calibration image imaged by the imaging device, input/output characteristic data (color spot correction parameters) are corrected based on the amount of correction, and the color spots of the projection image are corrected based on the corrected input/output characteristic data.

However, in the technique disclosed in JP-A-2005-24855, it is difficult to predict the color spots since the color spots occur differently with time for an individual projector. For this reason, this technique has a problem in that the color spots may not be properly corrected even when the correction for the color spots is performed using the color spot correction data having the different data values corresponding to the elapsed time.

In addition, in the technique disclosed in JP-A-2004-228948, there is a need to form the projection image on the screen when the amount of correction for color spots is calculated, that is, a user has to install the screen or a projector. For this reason, it is inconvenient for the user to use this technique. In addition, since this technique depends greatly on projection environments, it requires environments of a darkroom and the like to calculate the amount of correction properly.

### SUMMARY

An advantage of some aspects of the invention is to provide a projection system and a projector, which are capable of correcting color spot correction parameters properly for correction of color spots occurring in a projection image without projecting an image on a screen.

According to an aspect of the invention, there is provided a projection system including an information processing apparatus that processes image information, a projector including a light source, an optical modulation device that modulates light emitted from the light source based on the image information processed by the information processing apparatus and forms an optical image, and a projection optical apparatus that enlarges and projects the optical image to form a projection image, and an information transferring unit that interconnects the information processing apparatus and the projector for information exchange between the information processing apparatus and the projector, the projector including a light detecting part that is disposed at a rear side of an optical path of the optical modulation device, detects at least a portion of the optical image outputted from the optical modulation device, and outputs detection information, and, the information processing apparatus including a correction mode transferring part that transfers to a correction mode in which a predetermined optical image is formed by the optical modulation device and at least a portion of the optical image is detected in the light detecting part to correct a color spot correction parameter for correcting color spots occurring in the projection image; and a parameter correcting part that acquires the detection information outputted from the light detecting part via the information transferring unit and corrects the color spot correction parameter based on the acquired detection information in the correction mode.

Here, the color spots include luminance spots occurring due to a difference between optical brightness of pixels and brightness designed for the pixels in mixture of optical images having different color light, as well as color spots occurring due to a difference between an optical brightness ratio and a designed brightness ratio.

The parameter correcting part may generate new color spot correction parameters, or may generate correction information for correcting current color spot correction parameters.

In addition, an imaging device such as a CCD (Charge Coupled Device) or a MOS (Metal Oxide Semiconductor) sensor, or a light receiving device such as a photodiode may be employed as the light detecting part. In addition, the light detecting part may be disposed at any positions as long as it is disposed at the rear side of the optical path of the optical modulation device and can detect at least a portion of the optical image outputted from the optical modulation device. In addition, the light detecting part may be either built in the projector or detachably disposed in the projector in the correction mode, for example.

In addition, the color spot correcting part that performs the color spot correction process for the image information based on the color spot correction parameter may be provided in either the projector or the information processing apparatus.

In the aspect of the invention, the correction mode transferring part of the information processing apparatus transfers from a normal projection mode to project a projection image on a screen to the correction mode when a user inputs mode transfer information, which indicates transfer to the correction mode to correct the color spot correction parameter, through an operating part. After the transfer to the correction mode, the light detecting part of the projector detects at least a portion of the optical image that is formed in the optical modulation device and is outputted from the optical modulation device. In addition, the parameter correcting part of the information processing apparatus acquires the detection information outputted from the light detecting part, and corrects the color spot correction parameter based on the detection information. Accordingly, the light detecting part provided in the projector can directly detect the optical image outputted from the optical modulation device without projecting the optical image onto a screen. Accordingly, in the correction mode, it is convenient for a user since the user need not to install the screen or the projector. In addition, as described above, the color spot correction parameter can be properly corrected without depending on installation environments of the projector.

Accordingly, the color spot correction parameter to correct color spots occurring in a projection image can be properly corrected without projecting an image on the screen, and spots occurring in the projection image with time can be corrected using the corrected color spot correction parameter.

The projector may further include: a correction parameter storing part that stores the color spot correction parameter; and a color spot correcting part that performs a color spot correction process to correct the color spots occurring in the projection image for the image information processed in the information processing apparatus, based on the color spot correction parameter stored in the correction parameter storing part, and, the parameter correcting part updates the color spot correction parameter stored in the correction parameter storing part with the corrected color spot correction parameter.

Here, when it is configured that the parameter correcting part generates a new color spot correction parameter, the parameter correcting part updates the color spot correction parameter stored in the correction parameter storing part with the newly generated color spot correction parameter. In addition, when it is configured that the parameter correcting part generates correction information to correct the color spot correction parameter, the parameter correcting part updates the color spot correction parameter stored in the correction parameter storing part based on the generated correction information.

In addition, among various correction processes (for example, resolution conversion, contour emphasis, black/white expansion, color conversion, γ correction, VT-γ correction, ghost correction, cross-talk correction, color spot correction, etc.), it is most efficient to perform the color spot correction process at the last phase.

According to the aspect of the invention, the projector includes the correction parameter storing part and the color spot correcting part, and the color spot correction process is performed in the projector. Accordingly, compared to when the color spot correction process is performed in the information processing apparatus, the color spot correction process can be performed in the projector at the last phase, thereby allowing an image correction process to be performed most quickly.

The projector may further include a light source for correction that emits correction light to correct the color spot correction parameter to the optical modulation device in the correction mode.

Here, the light source for correction may be either built in the projector or detachably disposed in the projector in the correction mode, for example.

According to the aspect of the invention, since the projector includes the light source for correction for emitting correction light to the optical modulation device in the correction mode, separately from the light source, the information processing apparatus can uses the light source emitting light of an amount according to light received in the light detecting part in the correction mode and correct the color spot correction parameter properly based on the detection information outputted from the light detecting part. In addition, when the light source for correction includes a solid state light emitting device such as an LED, (Light Emitting Diode) with low intensity of illumination and low power consumption, power consumption can be reduced in the correction mode.

The projector may further include a light source driving controller that drives the light source, changes the amount of light emitted from the light source, and emits the changed amount of light to the optical modulation device in the correction mode.

According to the aspect of the invention, since the projector includes the light source driving controller, the reduced amount of light emitted from the light source can be outputted to the optical modulation device. Accordingly, the light of an amount according to light received in the light detecting part, can be emitted from the light source in the correction mode, and the information processing apparatus can correct the color spot correction parameter properly based on the detection information outputted from the light detecting part. In addition, low power consumption car be achieved in the correction mode. In addition, there is no need to provide a separate light source for correction, thereby achieving low costs of the projector.

The information transferring unit may include a power transmission line that supplies power from a power supply of the information processing apparatus to the projector, and, the projector further includes a power generating part that supplies a driving voltage to internal components of the projector in the correction mode, based on the power supplied via the power transmission line.

With this configuration, the power generating part of the projector supplies the driving voltage to internal components (for example, the light detecting part and so on) of the projector in the correction mode based on the power from the information processing apparatus via the information transferring unit. Accordingly, in the correction mode, the projector is driven based on the power from the information processing apparatus via the information transferring unit. It is unnecessary to connect the projector to an external power supply via an AC cable or the like. Accordingly, only by connecting the projector to the information processing apparatus via the information transferring unit, the color spot correction parameter can be corrected in the correction mode, thereby giving a user convenience more.

The light detecting part may include a light receiving element that receives at least a portion of the optical image outputted from the optical modulation device and outputs a light receiving signal based on the amount of received light.

According to the aspect of the invention, since the light detecting part includes the light receiving element, costs of the protector can be further reduced, for example, compared to when an imaging device is employed as the light detecting part.

According to another aspect of the invention, there is provided a projector including a light source, an optical modulation device that modulates light emitted from the light source based on image information and forms an optical image, and a projection optical apparatus that enlarges and projects the optical image to form a projection image, including: a light detecting part that is disposed at a rear side of an optical path of the optical modulation device, detects at least a portion of the optical image outputted from the optical modulation device, and outputs detection information; a correction parameter storing part that stores the color spot correction parameter to correct color spots occurring in the projection image; and a color spot correcting part that performs a color spot correction process to correct the color spots occurring in the projection image for the image information processed in the information processing apparatus, based on the color spot correction parameter stored in the correction parameter storing part. The correction parameter storing part updates the stored color spot correction parameter with the corrected color spot correction parameter, based on the detection information outputted from the light detecting part, in a correction mode to correct the color spot correction parameter based on the at least portion of the optical image detected in the light detecting part, while forming the optical image on the optical modulation device.

According to the aspect of the invention, since the projector includes the light detecting part, the correction parameter storing part and the color spot correcting part, the same operation and effects as the above-described projection system can be achieved.

The projector may further include: a correction mode transferring part that transfers to a correction mode in which a predetermined optical image is formed by the optical modulation device and at least a portion of the optical image is detected in the light detecting part to correct a color spot correction parameter for correcting color spots occurring in the projection image; and a parameter correcting part that corrects the color spot correction parameter based on the detection information outputted from the light detecting part and updates the color spot correction parameter stored in the correction parameter storing part with the corrected color spot correction parameter in the correction mode.

According to the aspect of the invention, since the projector includes the light receiving element, the correction parameter storing part, the color spot correcting part, the correction mode transferring part and the parameter correcting part, the same operation and effects as the above-described projection system can be achieved.

In addition, since the projector can correct the color spot correction parameter, the color spot correction parameter can be corrected without connecting the projector to the information processing apparatus via the information transferring unit, thereby giving a user convenience more.

The projector may further include a light source for correction that emits correction light to correct the color spot correction parameter to the optical modulation device in the correction mode.

According to the aspect of the invention, since the projector includes the light source for correction, the same operation and effects as the above-described projection system can be achieved.

The projector may further include a light source driving controller that drives the light source, changes the amount of light emitted from the light source, and emits the changed amount of light to the optical modulation device in the correction mode.

According to the aspect of the invention, since the projector includes the light source driving controller, the sage operation and effects as the above-described projection system can be achieved.

The projector may further include: an information transferring unit including a power transmission line that supplies power from a power supply of an information processing apparatus to the projector; and a power generating part that supplies a driving voltage to internal components of the projector in the correction mode, based on the power supplied via the power transmission line.

According to the aspect of the invention, since the projector includes the power generating part, the same operation and effects as the above-described projection system can be achieved.

The light detecting part may include a light receiving element that receives at least a portion of the optical image outputted from the optical modulation device and outputs a light receiving signal based on the amount of received light.

According to the aspect of the invention, since the light detecting part includes the light receiving element, the same operation and effects as the above-described projection system can be achieved.

The projector may further include a housing that accommodates the light source, the optical modulation device and the projection optical apparatus, the housing including an opening through which light projecting from the projection optical apparatus passes, a covering member being detachably arranged at the opening such that the opening can be closed/opened. The light detecting part is attached to the covering member, detects at least a portion of the optical image that is outputted from the optical modulation device and passes through the projection optical apparatus, and outputs detection information.

According to the aspect of the invention, since the light detecting part is attached to the covering member, there is no need to arrange the light detecting part in an optical path from the light source, through the optical modulation device, to the projection optical apparatus, thereby achieving a simplified structure of the projector. In addition, since the covering member is detachably attached to the opening, when the covering member is detached from the opening in the normal projection mode and the covering member is attached to the opening in the correction mode, at least a portion of the optical image that is outputted from the optical modulation device and passes through the projection optical apparatus can be detected in the light detecting part. Accordingly, the light detecting part can be arranged depending on a use mode of the projector, thereby giving a user convenience more.

The optical modulation device may be provided in plural numbers, and the projector may further include: a color composition optical device that mixes optical images formed in the plurality of optical modulation devices; and a housing that accommodates the light source, the plurality of optical modulation devices, the color composition optical device, and the projection optical apparatus, an insertion member being disposed between the color composition optical device and the projection optical apparatus. The light detecting part is attached to the insertion member, detects at least a portion of the optical images that are outputted from the optical modulation device and pass through the color composition optical device, and outputs detection information.

According to the aspect of the invention, since the light detecting part is attached to the insertion member, when the insertion member is detached from between the color composition optical device and the projection optical apparatus in the normal projection mode and the insertion member is disposed between the color composition optical device and the projection optical apparatus in the correction mode, at, least a portion of the optical image that is outputted from the optical modulation device and passes through the color composition optical device can be detected in the light detecting part. Accordingly, the light detecting part can be arranged depending on a use mode of the projector, thereby giving a user convenience more.

The optical modulation device may be provided in plural numbers, and the projector may further include: a color composition optical device that mixes optical images formed in the plurality of optical modulation devices; and a housing that accommodates the light source, the plurality of optical modulation devices, the color composition optical device, and the projection optical apparatus, a plurality of insertion members being disposed between the plurality of optical modulation devices and the color composition optical device. The light detecting part is attached to each of the plurality of insertion members, detects at least a portion of the optical image that is outputted from each of the optical modulation devices, and outputs detection information.

According to the aspect of the invention, since the light detecting part is attached to the plurality of insertion members, when the insertion members are detached from between the optical modulation devices and the color composition optical device in the normal projection mode and the insertion members are disposed between the optical modulation devices and the color composition optical device in the correction mode, at least a portion of the optical image that is outputted from the optical modulation device can be detected in the light detecting part. Accordingly, the light detecting part can be arranged depending on a use mode of the projector, thereby giving a user convenience more.

In addition, since optical images outputted from the optical modulation devices are detected in different light detecting parts, the optical images outputted from the optical modulation devices can be collectively detected in the light detecting parts to output detection information, without driving the optical modulation devices in order, compared to when the optical images outputted from the optical modulation devices are detected in the same light detecting part. Accordingly, the color spot correction parameter can be quickly generated and updated in the correction mode.

### BRIEF DESCRIPTION OF THE DRAWINGS

The invention will be described with reference to the accompanying drawings wherein like numbers reference like elements.

FIG. 1 is an external view of a projection system according to a first embodiment of the invention.

FIG. 2 is a block diagram showing a general configuration of a PC according to the first embodiment.

FIGS. 3A to 3B are views showing an example of a color spot correction parameter generating method of a color spot correction parameter generating part according to the first embodiment.

FIG. 4 is a view showing an example of information displayed on a displaying part according to the first embodiment.

FIG. 5 is a schematic plan view showing an optical system of a projector according to the first embodiment.

FIG. 6 is a block diagram snowing a general configuration of a projector according to the first embodiment.

FIG. 7 is a flow chart illustrating an operation of a projection system according to the first embodiment.

FIG. 8 is a schematic plan view showing an optical system of a projector according to a second embodiment of the invention.

FIG. 9 is a schematic plan view showing an optical system of a projector according to a third embodiment of the invention.

FIG. 10 is a schematic plan view showing an optical system of a projector according to a four embodiment of the invention.

FIG. 11 is a block diagram showing a general configuration of a projector according to a fifth embodiment of the invention.

FIG. 12 is a flow chart illustrating an operation of the projector according to the fifth embodiment.

FIG. 13 is a view showing a modification of each of the above embodiments.

FIG. 14 is a view showing a modification of each of the above embodiments.

### DESCRIPTION OF EXEMPLARY EMBODIMENTS

### First Embodiment

Hereinafter, a first embodiment of the invention will be described with reference to the accompanying drawings.

Configuration of Projection System

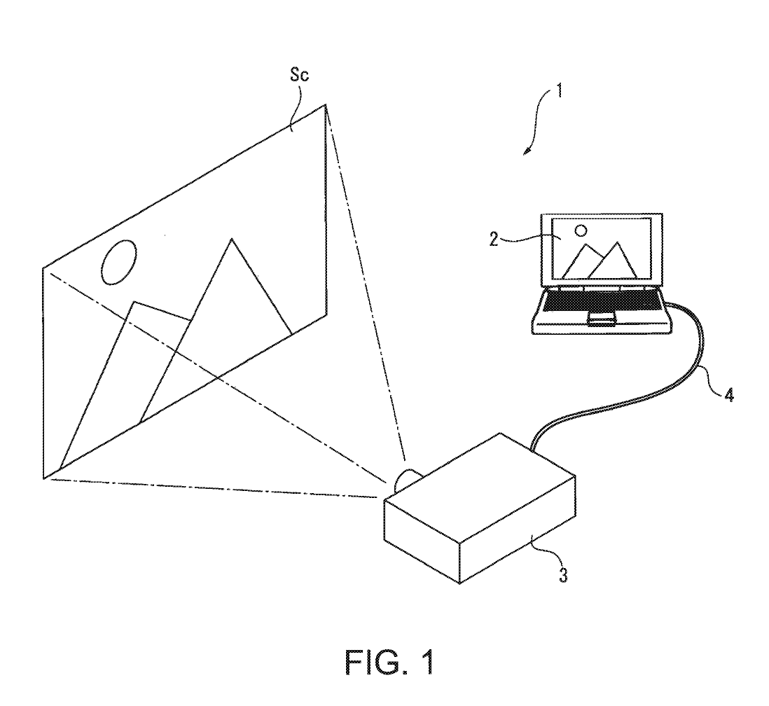

FIG. 1 is an external view of a projection system 1.

As shown in FIG. 1, the projection system 1 includes a personal computer (PC) 2 as an information processing apparatus that performs an image process for an image from an image source and outputs an image data signal, a projector 3 that generates a current image frame based on the image data signal from the PC 2 and projects the generated current image frame on a screen Sc, and a USB (Universal Serial Bus) cable 4 as information transfer means that interconnects the PC 2 and the projector 3 for data exchange therebetween.

Configuration of PC

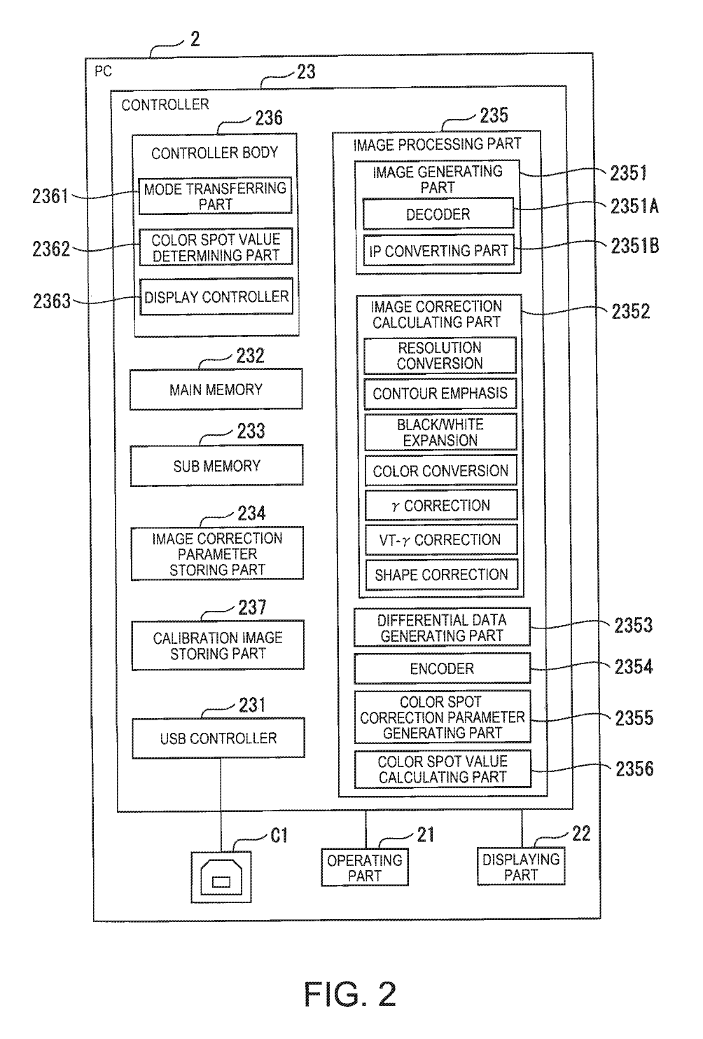

FIG. 2 is a block diagram showing a general configuration of the PC 2.

As shown in FIG. 2, the PC 2 generally includes an operating part 21, a displaying part 22 and a controller 23.

The operating part 21 has various kinds of operating buttons for data input, such as a keyboard, a mouse and so on. When one of the operation buttons is pushed to input data, the controller 23 starts to operate, and at the same time, details of the operation of the controller 23 are set for the information displayed on the displaying part 22. In addition, when a user operates the operating part 21, an appropriate predetermined operation signal is outputted from the operating part 21 to the controller 23.

The operating part 21 may be configured to input and set various conditions by a touch panel or through voice, without being limited to the operating buttons.

The displaying part 22 is controlled by the controller 23 to display predetermined kinds of information. For example, the displaying part 22 displays information processed by the controller 23, or, when the operating part 21 is operated to input, set or update information to be stored in a memory of the controller 23, which will, be described later, displays data that are stored in the memory and are outputted from the controller 23. The displaying part 22 may include, for example, a liquid crystal display device, an organic EL (Electroluminescence) display device, a PDP (Plasma Display Panel), a CRT (Cathode-Ray Tube) or the like.

The controller 23 executes a predetermined program and controls the whole of the PC 2 based on an operation signal inputted from the operating part 21. As shown in FIG. 2, the controller 23 includes a USB controller 231, a main memory 232, a sub memory 233, an image correction parameter storing part 234, an image processing part 235, a controller body 236, a calibration image storing part 237, etc. These components 231 to 237 are interconnected by a bus (not shown) for information exchange among them.

The USB controller 231 is electrically connected to the projector 3 via the USB cable 4 for data communication with the projector 3 according to an USB standard.

Although not shown, the USB cable 4 has four lines, that is, D+/D− signal lines, a VCC (+5 V) power line and a GND line, which are power transmission lines. The PC 2 can exchange data with the projector 3 via the USB cable 4, and power can be supplied from a power supply (not shown) of the PC 2 to the projector 3 via the power lines of the USB cable 4.

The main memory 232 stores various kinds of data. The data may include, for example, the operation signal outputted from the operating part 21, data inputted through he USB controller 231, data to be processed in the image processing part 235 and the controller body 236, etc.

The sub memory 233 may include media of an image source, for example, a DVD (Digital Versatile Disc) or the like in which images and voice are recorded as digital data.

The image correction parameter storing part 234 stores correction parameters for image correction according to a characteristic of the projector 3

In this embodiment, an image correction process may include a correction process of converting pixel color, luminance and resolution in the unit of pixel according to a display characteristic of the projector 3 and a correction process of correcting color spots over a plurality of adjacent pixels, such as a ghost correction process or a cross-talk correction process which corrects color spots occurring due to other pixels.

The image process performed in the PC 2 is mainly a correction process of converting pixel color, luminance and resolution in the unit of pixel.

For example, correction parameters stored in the image correction parameter storing part 234 may include various kinds of correction parameters for resolution conversion, contour emphasis, black/white expansion, color conversion, γ correction, VT-γ correction, etc.

Such a correction process is only to convert pixel data, and accordingly, has slight change of differential data, compared to differential data between image frames in an original image before and after the correction process.

In addition, in this embodiment, since the differential data is not so large, a shape correction parameter for correction of a shape of an image may be also stored in the image correction parameter storing part 234 of the PC 2.

In addition, a memory card or a CD-ROM in which these correction parameters are recorded may be inserted in the PC 2 so that the correction parameters can be installed (i.e., stored) in the image correction parameter storing part 234.

Alternatively, when the PC 2 is connected to the projector 3 via the USB cable 4, the PC 2 may read predetermined correction parameters from the projector 3 and store the read correction parameters in the image correction parameter storing part 234.

The calibration image storing part 237 stores calibration image information (calibration image data) related to a calibration image to be displayed on the projector 3 in a correction mode which will be described later.

The calibration image data may include image information related to an image having gray scales (except a gray scale of 0) in predetermined pixels or a predetermined region constituted by a plurality of pixels and a gray scale of 0 (black) in other pixels or other pixel regions. In addition, The calibration image storing part 237 stores a plurality of calibration image data having plural-phased gray scales in every pixel or every pixel region.

The image processing part 235 includes, for example, a GPU (Graphics Processor Unit) and so on and corrects color spot correction parameters for a color spot correction process to be performed in the projector 3 while performing the above-described image correction process. As shown in FIG. 2, the image processing part 235 includes an image generating part 2351, an image correction calculating part 2352, a differential data generating part 2353, an encoder 2354, a color spot correction parameter generating part 2355 and a color spot value calculating part 2356. The color spot correction parameter generating part 2355 and the color spot value calculating part 2356 constitute a parameter correcting part.

As shown in FIG. 2, the image generating part 2351 includes a decoder 2351A and an IP converting part 2351B, decrypts image data (image information) for each frame of an image source from the sub memory 233 according to a recording system, and outputs the decrypted image data to the image correction calculating part 2352.

The image correction calculating part 2352 corrects the decrypted image data outputted from the image generating part 2351, according to a characteristic of the projector 3. The image correction calculating part 2352 outputs the corrected image data to the differential data generating part 2353. This correction process may include, for example, various kinds of processes for resolution conversion, contour emphasis, black/white expansion, color conversion, γ correction, VT-γ correction, shape correction, etc.

The differential data generating part 2353 compares the latest image data of the corrected image data outputted from the image correction calculating part 2352 with an image data immediately before the latest image data, and detects a difference between the latest image data and the image data immediately before the latest image data as a differential data. That is, the differential data include spatial variation and color variation of the latest image data with respect to the image data immediately before the latest image data. The differential data generating part 2353 outputs the differential data to the encoder 2354.

The encoder 2354 encodes the differential data outputted from the differential data generating part 2353. The differential data encoded by the encoder 2354 is transmitted to the projector 3 via the USB controller 231 and the USB cable 4.

The color spot correction parameter generating part 2355 generates a color spot correction parameter used to correct color spots in the projector 3, based on light receipt information transmitted from the projector 3 via the USB cable 4, in a correction mode which will be described later. In addition, the color spot correction parameter generating part 2355 transmits the generated color spot correction parameter to the projector 3 via the USB controller 231 and the USB cable 4. The projector 3 updates the transmitted color spot correction parameter.

Here, the color spot correction parameter is a data indicating a relation between brightness (for example, gray scale) of an input signal and brightness of an output signal, for example.

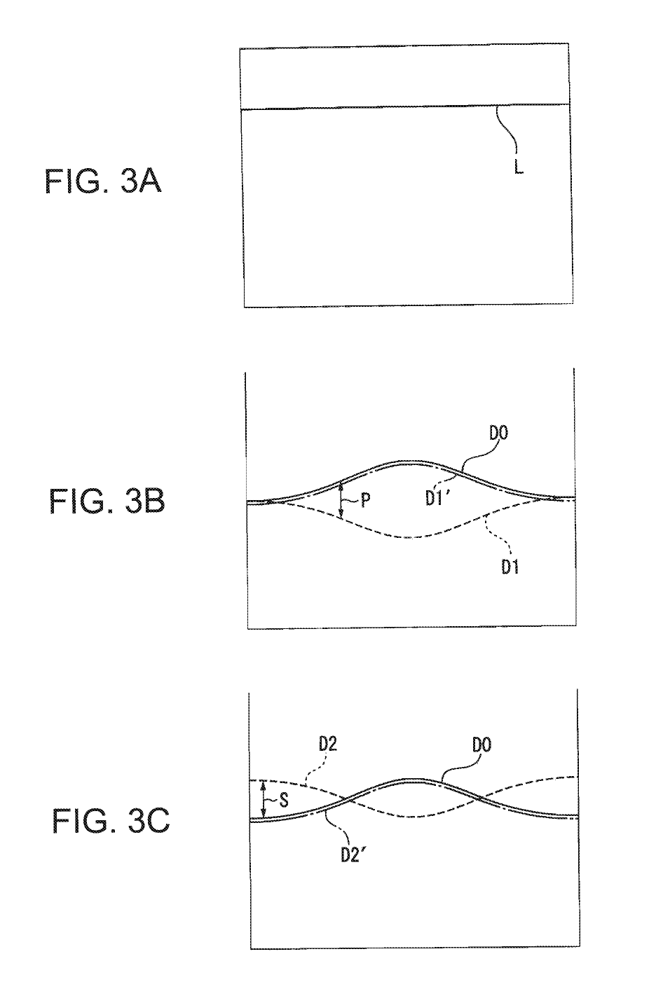

FIGS. 3A to 3B are views showing an example of a color spot correction parameter generating method of the color spot correction parameter generating part 2355. Specifically, FIG. 3A shows all pixel regions (one screen). FIG. 3B shows a distribution of brightness (brightness value, for example) based on light receipt information on light (G color light) received through a G color liquid crystal light valve, which will be described later, on a horizontal line L shown in FIG. 3A. FIG. 3C shows a distribution of brightness based on light receipt information on light (G color light) received through the G color liquid crystal light valve and light (R or B color light) received through a liquid crystal light valve other than the G color liquid crystal light valve, which will be described later, on the horizontal line L shown in FIG. 3A.

For example, as shown in FIG. 3B, the color spot correction parameter generating part 2355 recognizes a brightness distribution D1 of the G color light on the horizontal line L based on the light receipt information transmitted from the projector 3, and generates the color spot correction parameter for correcting the brightness distribution D1 for each pixel or each pixel region to be a brightness distribution D1′ having a predetermined ratio of recognized brightness of the G color light to designed brightness of the G color light for a designed brightness distribution D0 of the G color light on the horizontal line L, which is stored in the memory 232 or the like. In addition, the color spot correction parameter generating part 2355 generates color spot correction parameters sequentially for different horizontal lines L and generates color spot correction parameters used for the G color liquid crystal light valve, which will be described later, for every pixel or every pixel region.

In addition, if the light receipt information is based on the above-mentioned calibration image having highest gray scale value, since a gray scale value can not be increased any more, the color spot correction parameter generating part 2355 generates the color spot correction parameter for correcting the brightness distribution D1 to be the brightness distribution D1′ similar to the brightness distribution D0 by correcting a gray scale value corresponding to a brightness portion in the brightness distribution D1 to be a lower gray scale value.

On the other hand, if the light receipt information is based on the above-mentioned calibration image having a gray scale value other than the highest gray scale value, since a gray scale value can be increased any more, the color spot correction parameter generating part 2355 generates the color spot correction parameter for correcting the brightness distribution D1 to be the brightness distribution D1′ equal or similar to the brightness distribution D0 by correcting a gray scale value to be a higher gray scale value.

In addition, for example, as shown in FIG. 30, the color spot correction parameter generating part 2355 recognizes a brightness distribution D2 of the R or B color light on the horizontal line L based on the light receipt information transmitted from the projector 3, and generates a color spot correction parameter for correcting the brightness distribution D2 to be a brightness distribution D2′ having a predetermined ratio of the brightness of the R or B color light to the brightness of the G color light for the designed brightness distribution D0 of the G color light. In addition, the color spot correction parameter generating part 2355 generates color spot correction parameters sequentially for different horizontal lines L and generates color spot correction parameters used for the R or B color liquid crystal light valve, which will be described later, for every pixel or every pixel region.

In addition, if the light receipt information is based on the above-mentioned calibration image having highest gray scale value, since a gray scale value can not be increased any more, the color spot correction parameter generating part 2355 generates the color spot correction parameter for correcting the brightness distribution D2 to be the brightness distribution D2′ similar to the brightness distribution D0 by correcting a gray scale value corresponding to a brightness portion in the brightness distribution D2 to be a lower gray scale value.

On the other hand, if the light receipt information is based on the above-mentioned calibration image having a gray scale value other than the highest gray scale value, since a gray scale value can be increased any more, the color spot correction parameter generating part 2355 generates the color spot correction parameter for correcting the brightness distribution D2 to be the brightness distribution D2′ equal or similar to the brightness distribution D0 by correcting a gray scale value to be a higher gray scale value.

In the correction mode, which will be described later, based on the light receipt information transmitted from the projector 3 via the USB cable 4, the color spot value calculating part 2356 calculates a difference between the designed brightness distribution D0 of the G color light for each pixel or each pixel region and the brightness distribution D1 of the G color light as a luminance spot value P, for example, as shown in FIG. 3B, while calculating a difference between the designed brightness distribution D0 of the G color light for each pixel or each pixel region and the brightness distribution D1 of the R or B color light as a color spot value S, for example, as shown in FIG. 3C.

The controller body 236 includes a CPU (Central Processing Unit, and the like and controls the whole of the PC 2 according to a predetermined program stored in the main memory 232 or the like. The controller 236 also includes a mode transferring part 2361, a color spot determining part 2362, a display controlling part 2363 and so on.

The display controlling part 2363 controls driving of the displaying part 22 and displays predetermined information on the displaying part 22. The information displayed on the displaying part 22 according to the driving control of the displaying part 22 by the display controlling part 2363 may include the following information, for example.

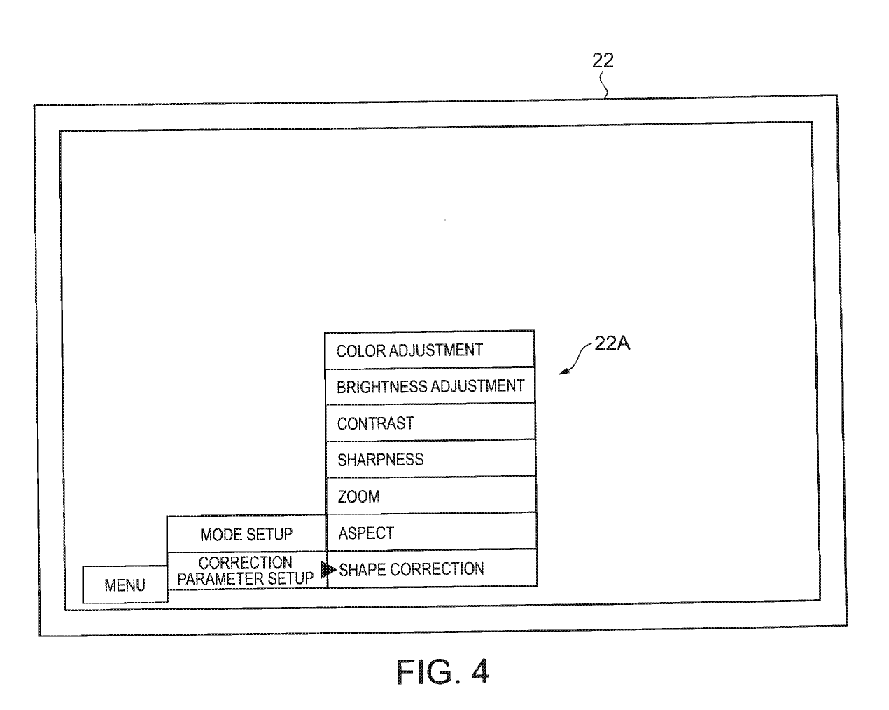

FIG. 4 is a view showing an example of information displayed on the displaying part 22.

For example, information on menu for selection of a mode (projection mode or correction mode) of the projector 3 or setup of correction parameters are stored in the main memory 232 or the like. The menu information of setup of the correction parameters may include, for example, information related to color adjustment, brightness adjustment and the like. The correction parameters may include, for example, correction parameters for resolution conversion, contour emphasis, black/white expansion, color conversion, γ correction, VT-γ correction, shape conversion, ghost correction, cross-talk correction, color spot correction, etc.

According to an operation signal outputted from the operating part 21, the display controlling part 2363 displays a menu 22A based on the menu information on the displaying part 22, as shown in FIG. 4. A user can select a mode of the projector 3 or set a correction parameter by operating the menu through the operating part 21.

In addition, the display controlling part 2363 counts driving time of the projector 3 (driving time of a liquid crystal light valve which will be described later) by means of a timer or the like, and, after the counted driving time reaches preset time, displays information indicating update of the color spot correction parameters on the displaying part 22 to urge a user to transfer to the correction mode.

The mode transferring part 2361 transfers to the projection mode or the correction mode.

For example, when the menu 22A is operated through the operating part 21 to input and set mode transfer information indicating transfer to the projection mode and transfer to the correction mode, the mode transferring part 2361 inputs an operation signal as the mode transfer information outputted from the operating part 21. The mode transferring part 2361 transfers to the projection mode or the correction mode based on the mode transfer information.

Here, the projection mode refers to a mode in which the PC 2 transmits an image data (the above-mentioned differential data) to the projector 3 via the USB cable 4, and the projector 3 projects an optical image according to the image data.

Specifically, in case of transfer to the projection mode, the mode transferring part 2361 transmits a control command to the projector 3 via the USB cable 4.

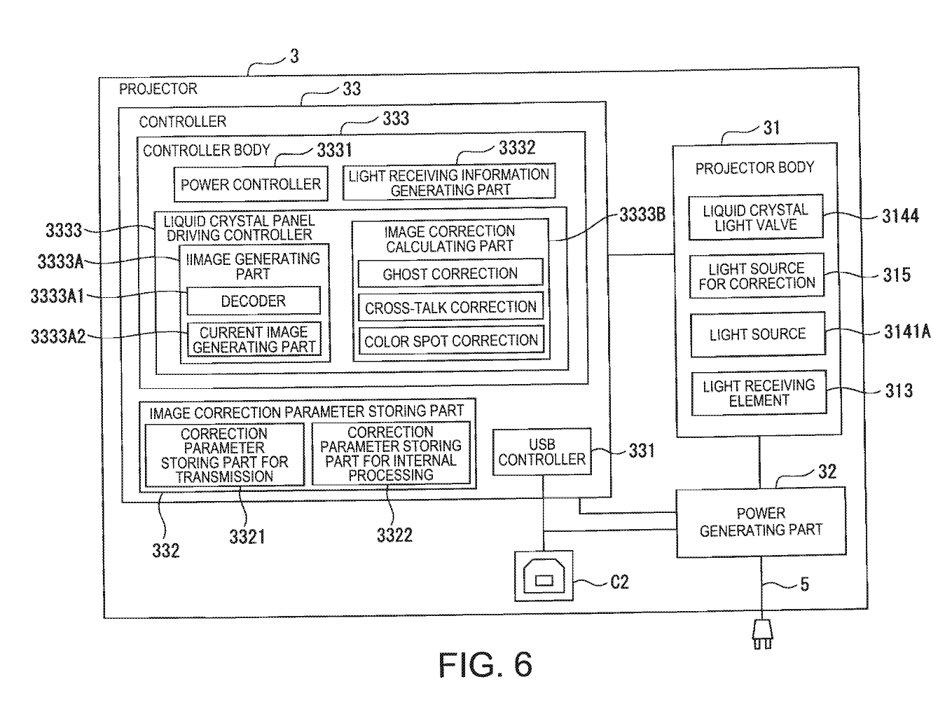

Here, the control command transmitted to the projector 3 via the USB cable 4 in case of the transfer to the projection mode may include, for example, a control command to set a driving voltage supplied to the controller and a light source of the projector 3, which will be described later, to be a driving voltage based on power supplied from an external power supply via an AC cable 5 (see FIG. 6).

The correction mode refers to a mode for correcting a color spot correction parameter used when the protector 3 perform color spot correction for an image data.

Specifically, in case of transfer to the correction mode, the mode transferring part 2361 transmits a predetermined control command and a calibration image data stored in the calibration image storing part 237 to the projector 3 via the USB cable 4.

Here, the predetermined control command transmitted to the projector 3 via the USB cable 4 in case of the transfer to the correction mode may include,

for example, a control command to set a driving voltage supplied to the controller, a light source for correction, and a light receiving device of the projector 3, which will be described later, to be a driving voltage based on power supplied via the USB cable 4, a control command to drive the light source for correction, a control command to form an optical image based on the calibration image data, a control command to receive at least a portion of the optical image in the light receiving device to generate light receipt information, etc.

In case of the transfer to the correction mode, the mode transferring part 2361 outputs a predetermined control command to the image processing part 235 to allow the color spot correction parameter generating part 2355 and the color spot value calculating part 2356 to execute processing.

In the correction mode, the color spot value determining part 2362 recognizes the luminance spot value P or the color spot value S calculated in the color spot value calculating part 2356, compares the luminance spot value P or the color spot value S with a reference value stored in the main memory 232 or the like, and determines whether or not the luminance spot value P or the color spot value S falls within a range of the reference value. That is, the color spot value determining part 2362 determines whether or not luminance spots or color spots occur in the projection image depending on whether or not the luminance spot value P or the color spot value S falls within the range of the reference value.

Configuration of Projector

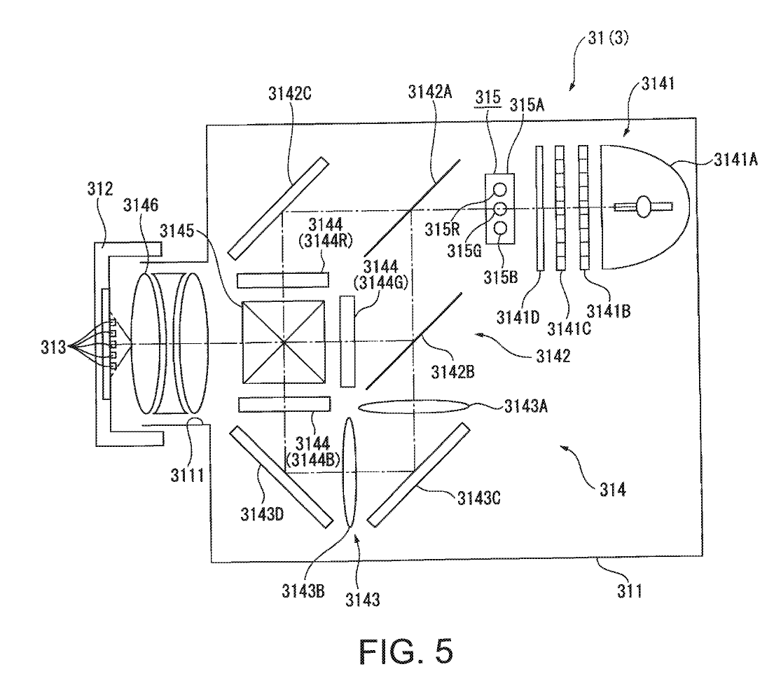

FIG. 5 is a schematic plan view showing an optical system of the projector 3.

FIG. 6 is a block diagram showing a general configuration of the projector 3.

As shown in FIG. 5 or 6, the projector 3 generally includes a projector body 31, a power generating part 32 (FIG. 6), and a controller 33 (FIG. 6).

The projector body 31 forms an optical image and enlarges and projects the formed optical image on a screen Sc under control of the controller 33. As shown in FIG. 5, the projector body 31 includes a housing 311, a lens cover 312 as a covering member, a plurality of light receiving elements 313 as a light detecting part, an optical unit 314, and a light source 315 for correction.

As shown in FIG. 5, the housing 311 is a case in which the optical unit 314 and the light source 315 for correction are accommodated. In addition to the optical unit 314 and the light source 315 for correction, although not shown in FIG. 5, the power generating part 32, the controller 33, etc. are arranged in the housing 311.

As shown in FIG. 5, an opening 3111 to expose a front end portion of a projection lens, which will be described later, constituting the optical unit 314 is formed at a front side of the housing 311. The optical image is enlarged and projected onto the screen Sc through the opening 3111.

As shown in FIG. 5, the lens cover 312 is a detachable covering member formed at the circumference of the opening 3111 of the housing 311. That is, when the projector 3 enlarges and projects the optical image (in the projection mode), the lens cover 312 is detached from the housing 311. If the projector 3 does not project the optical image (for example, in the correction mode), the lens cover 312 is attached to the housing 311.

As shown in FIG. 5, the plurality of light receiving elements 313 are attached to a rear side of the lens cover 312 (that is, a side opposite the opening 3111 when the lens cover 312 is attached to the housing 311), and are electrically connected to the controller 33 when the lens cover 312 is attached to the housing 311. The plurality of light receiving elements 313 receive the optical image emitted through the opening 3111 under control of the controller 33. In addition, the light receiving elements 313 output a light receiving signal as detecting information according to the amount of received light (brightness) to the controller 33. The light receiving elements 313 may include, for example, photodiodes or the like.

In addition, the position of light receiving elements 313 relative to the lens cover 312 and the number of light receiving elements 313 are not particularly limited as long as they can receive at least a portion of the optical image through the opening 3111.

For example, the light receiving elements may be a ranged in plural at a rear side of the lens cover 312 in correspondence to all pixels over an irradiation region of the optical image trough the opening 3111.

Alternatively, the light receiving elements may be arranged in plural at a rear side of the lens cover 312 at predetermined intervals over the irradiation region.

Alternatively, the light receiving elements may be arranged in plural at a rear side of the lens cover 312 in a region in which liquid crystal light valves and the like as optical elements constituting the optical unit 314, which will be described later, are likely to be thermally deteriorated, for example, in substantially a central portion of the irradiation region.

In addition, as described above, a single light receiving element 313 may be disposed. In this case, for example, if a diffusion plate or the like is disposed at a light incident side of the light receiving element 313, the optical image passes through the diffusion plate so that light is uniformly irradiated on the irradiation region, thereby allowing the single light receiving element 313 to receive the optical image.

As shown in FIG. 5, the optical unit 314 includes an illumination optical system 3141, a color separation optical system 3142, a relay optical system 3143, three liquid crystal light valves 3144 as optical modulating elements, a cross dichroic prism 3145 as a color composition optical device, and a projection lens 3146 as a projection optical device.

The illumination optical system 3141 is an optical system for illuminating image forming regions of the liquid crystal light valves 3144 substantially uniformly. As shown in FIG. 5, the illumination optical system 3141 includes a light source 3141A, a first lens array 3141B, a second lens array 3141C, a polarization converting element 3141D, etc.

The light source 3141A emits light under control of the controller 33. Although not shown in the figure, the light source 3141A includes a light source lamp and a lamp driver.

The light source lamp may include a super-pressure mercury lamps or alternatively, other discharge emission-typed lamps such as a metal halide lamp or a xenon lamp. Alternatively, without being limited to the discharge emission-typed lamps, the light source lamp may include various solid-typed light emitting devices such as a light emitting diode, a laser diode, an organic EL element, a silicon light emitting device and the like.

The lamp driver drives the light source lamp with a predetermined driving voltage under control of the controller 33.

The first lens array 3141B includes substantially rectangular small lenses arranged in the form of a matrix when viewed from an optical axis direction. Each small lens splits light emitted from the light source 3141A into a plurality of partial light beams.

The second lens array 3141C includes small lenses that have substantially the same shape as the first lens array 3141C and are arranged in the form of a matrix when viewed from an optical axis direction. The second lens array 3141C forms images of the small lenses of the first lens array 3141B on the image forming regions of the liquid crystal light valves 3144.

The polarization converting element 3141D converts light from the second lens array 3141C into substantially one kind of polarized light.

As shown FIG. 5, the color separation optical system 3142 includes two dichroic mirrors 3142A and 3142B and reflection mirror 3142C and separates the plurality of partial light beams emitted from the illumination optical system 3141 into light having three red, green and blue colors by means of the dichroic mirrors 3149A and 3142B.

The relay optical system 3143 includes an incident side lens 3143A, a relay lens 3143B and reflection mirrors 3143C and 3143D and guides the color light, which is separated by the color separation optical system 3142, to a liquid crystal light valve for blue color light.

At this time, the dichroic mirror 3142A of the color separation optical system 3142 transmits a red color light component of the light emitted from the illumination optical system 3141 while reflecting green and blue color light components of the light emitted from the illumination optical system 3141. The red color light component transmitted through the dichroic mirror 3142A is reflected by the reflection mirror 3142C and arrives at a liquid crystal light valve 3144R for red color light. In addition, the green color light component reflected by the dichroic mirror 3142A is reflected by the dichroic mirror 3142B and arrives at a liquid crystal light valve 3144G for green color light. On the other hand, the blue color light component passes through the dichroic mirror 3142B and arrives at a liquid crystal light valve 3144B for blue color light via the relay optical system 3143. The reason for using the relay optical system 3143 for the blue color light component is to prevent light use efficiency from being lowered due to light diffusion which may occur since an optical path of the blue color light component is longer than those of other color light components, that is, that a partial light beam incident into the incident side lens 3143A is all delivered to the liquid crystal light valve 3144B for blue color light. Although it is configured in this embodiment that the blue color light component of three color light components passes through the relay optical system 3143, or example, it may be configured that the red color light component passes through the relay optical system 3143.

The three liquid crystal light valves 3144 (the liquid crystal light valve 3144R for red color light, the liquid crystal light valve 3144G for green color light, and the liquid crystal light valve 3144B for blue color light), which are transmission-typed liquid crystal panels, output an optical image according to an image data processed in the PC 2 by varying alignment of liquid crystal molecules injected into liquid crystal cells (not shown) based on a driving signal from the controller 33 and transmitting or intercepting light emitted from the light source 3141A.

The cross dichroic prism 3145 is an optical device that is disposed at a rear stage of an optical path of each of the liquid crystal light valves 3144 and forms an color image by mixing optical images modulated for color light components emitted from the liquid crystal light valves 3144. The cross dichroic prism 3145 having a square shape when viewed from the top is constituted by four right-angled prisms that are bonded together, with a two-layered dielectric film formed at interfaces therebetween. The two-layered dielectric film reflects light emitted from the liquid crystal light valves 3144R and 3144B and transmits light emitted from the liquid crystal light valve 3144G. Thus, the color light components modulated in the liquid crystal light valves 3144 are mixed to form a color image.

The projection lens 3146 enlarges and projects the color image formed by the cross dichroic prism 3145 on the screen Sc.

The light source 315 for correction is detachably configured on an optical path of the optical unit 314 inside the housing 311 and is electrically connected to the controller 33 when installed inside the housing 311. In the correction mode to be described later, the light source 315 for correction is turned on/off under control of the controller 33 and emits correction light to correct a color spot correction parameter to the liquid crystal light valves 3144. In this embodiment, as shown in FIG. 5, the light source 315 for correction is disposed between the polarization converting element 3141D and the dichroic mirror 3142A. The light source 315 for correction includes an R color LED (Light Emitting Diode) module 315R for emitting R color light, a G color LED module 315G for emitting G color light, and a B color LED module 315B for emitting B color light, and a supporting base 315A for detachable supporting these LED modules 315R, 315G and 315B inside the housing 311.

These LED modules 315R, 315C, and 315B have substantially the same configuration, and, although not shown, have a plurality of LED elements as solid-typed light emitting elements arranged on a Si substrate, respectively. In addition, the LED elements constituting these LED modules 315R, 315G and 315B are formed to have different kinds of crystals and different additives, respectively, for emitting R, G and B color light, respectively.

In addition, the light source 315 for correction is not limited the above LED modules, but may include other various kinds of solid-typed light emitting devices such as a laser diode, an organic EL device, a silicon light emitting device and the like.

The power generating part 32 supplies power supplied from an external power supply via the AC cable 5 (see FIG. 6) connected to the external power supply and power supplied from the PC 2 via the JSB cable 4 to components of the projector 3. Specifically, the power generating part 32 includes a power converting circuit for converting an AC voltage supplied from the external power sup ply via the AC cable 5 into a DC voltage as a driving voltage having a predetermined stable level, or a power converting circuit for converting a VCC voltage supplied from the PC 2 via the USB cable 4 into a DC driving voltage.

The power generating part 32 operates under control of the controller 33 as will be described below.

For example, in case of the transfer to the projection mode, the power generating part 32 converts the AC voltage supplied from the external power supply via the AC cable 5 into the DC voltage to generate the driving voltage having the predetermined stable level, and supplies the generated driving voltage to the light source 3141A and the controller 33.

In addition, in case of the transfer to the correction mode, the power generating part 32 converts the VCC voltage supplied from the PC 2 via the USB cable 4 into the DC driving voltage, and supplies the DC driving voltage to the light receiving element 313, the light source 315 for correction, and the controller 33. That is, in case of the correction mode, the light source 3141A is turned off.

In addition, in this embodiment, the power generating part 32 converts the VCC voltage supplied from the PC 2 via the USB cable 4 into the DC driving voltage in a state where the AC cable 5 is separated from a plug socket or the projector 3 while the projector 3 and the PC 2 are connected to the USB cable 4, and supplies the DC driving voltage to at least the controller 33.

The controller 33 controls the whole of the projector 3 according to a control command from the PC 2. As shown in FIG. 6, the controller 33 includes a USB controller 331, an image correction parameter storing part 332 a controller body 333, etc. These components 331 to 333 are interconnected by a bus (not shown) for data exchange among them.

The USB controller 331, which is of the same type as the USB controller 331 of the PC 2, is electrically connected to the PC 2 via the USB cable 4 when a USB connector C1 of the PC 2 (see FIG. 2) and a USB connector C2 of the projector 3 (see FIG. 6) are connected to the USB cable 4 for data exchange With the PC 2 according to a USB standard.

As shown in FIG. 6, the image correction parameter storing part 332 includes a correction parameter storing part 3321 for transmission and a correction parameter storing part 3322 for internal processing.

The correction parameter storing part 3321 for transmission stores correction parameters for correction of an image in the PC 2.

The correction parameters stored in correction parameter storing part 3321 for transmission may include correction parameters for resolution conversion, contour emphasis, black/white expansion, color conversion, γ correction, VT-γ correction, and shape conversion.

When the PC 2 is connected to the projector 3 via the USB cable 4, the PC 2 reads the correction parameters stored in correction parameter storing part 3321 for transmission and stores the read correction parameter in the image correction parameter storing part 234.

The correction parameter storing part 3322 for internal processing stores correction parameters for image processing in the projector 3.

The correction parameters stored in correction parameter storing part 3322 for internal processing may include correction parameters for ghost correction, cross-talk correction and color spot correction. Of these parameters, the color spot correction parameter is updated whenever a new color spot correction parameter generated in the PC 2 in the correction mode is transmitted via the USB cable 4.

Here, cross-talk refers to an image spot occurring when a pixel is driven due to current leaking from an adjacent pixel, and ghost refers to overlap of displaced images.

Here, the reason why the ghost correction and the cross-talk correction are performed in the projector 3 is that data transfer at a transfer rate of the USB cable 4 is delayed since a differential data becomes large if the ghost correction and the cross-talk correction are performed in the PC 2.

In addition, it is advantageous to perform the color spot correction at the last phase in the projector 3, for example, after performing the ghost correction and the cross-talk correction in the projector 3.

The controller body 333 may include, for example, a CPU and controls the whole of the projector 3 according to a control command from the PC 2. As shown in FIG. 6, the controller body 333 includes a power controller 3331, a light receiving information generating part 3332, a liquid crystal panel driving controller 3333, etc.

As shown in FIG. 6, the liquid crystal panel driving controller 3333 includes an image generating part 3333A and an image correction calculating part 3333B as a color soot correcting part.

As shown in FIG. 6, the image generating part 3333A includes a decoder 3333A1 and a current image generating part 3333A2.

The decoder 3333A1 demodulates image data transmitted from the PC 2. That is, the differential data are obtained when the image data encoded in the encoder 2354 of the PC 2 are demodulated by the decoder 3333A1.

The current image generating part 3333A2 generates new current image data by mixing the demodulated differential data with currently projecting image data.

The image correction calculating part 3333B performs correction processes, such as a ghost correction process, a cross-talk correction process, a color spot correction process and the like, for the current image data generated in the current image generating part 3333A2, using various correction parameters stored in the correction parameter storing part 3322 for internal processing. Then, a driving signal based on the current image data corrected in the image correction calculating part 3333B is outputted to the liquid crystal light valves 3144 in which an optical image based on the corrected current image data is formed.

In addition, the liquid crystal driving controller 3333 performs the above-mentioned correction processes for the calibration image data transmitted from the PC 2 in the correction mode so that an optical image based on the corrected calibration image data (calibration image) is formed in the liquid crystal light valves 3144.

The power controller 3331 drives the power generating part 32 according to a control command from the PC 2 or a program stored in a memory (not shown).

For example, the power controller 3331 drives the power generating part 32 according to a control command to transfer to the projection mode, which is transmitted from the PC 2, generates a driving voltage based on power supplied via the AC cable 5, and supplies the generated driving voltage to the light source 3141A and the controller 33.

In addition, for example, the power controller 3331 drives the power generating part 32 according to a control command to transfer to the correction mode, which is transmitted from the PC 2, generates a driving voltage based on power supplied from the PC 2 via the USB cable 4, and supplies he generated driving voltage to the light receiving elements 313, the light source 315 for correction, and the controller 33.

The light receiving information generating part 3332 receives light receiving signals outputted from the light receiving elements 313, and generates light receiving information related to the amount of received light (brightness) and the positions of the light receiving elements 313 positions corresponding to pixels or pixel regions based on the light receiving signal. Then, the light receiving information generating part 3332 transmits the generated light receiving information to the PC 2 via the USB controller 331 and the USB cable 4.

Operation of Projection System

Next, an operation of the above-described projection system 1 will be described with reference to the accompanying drawings.

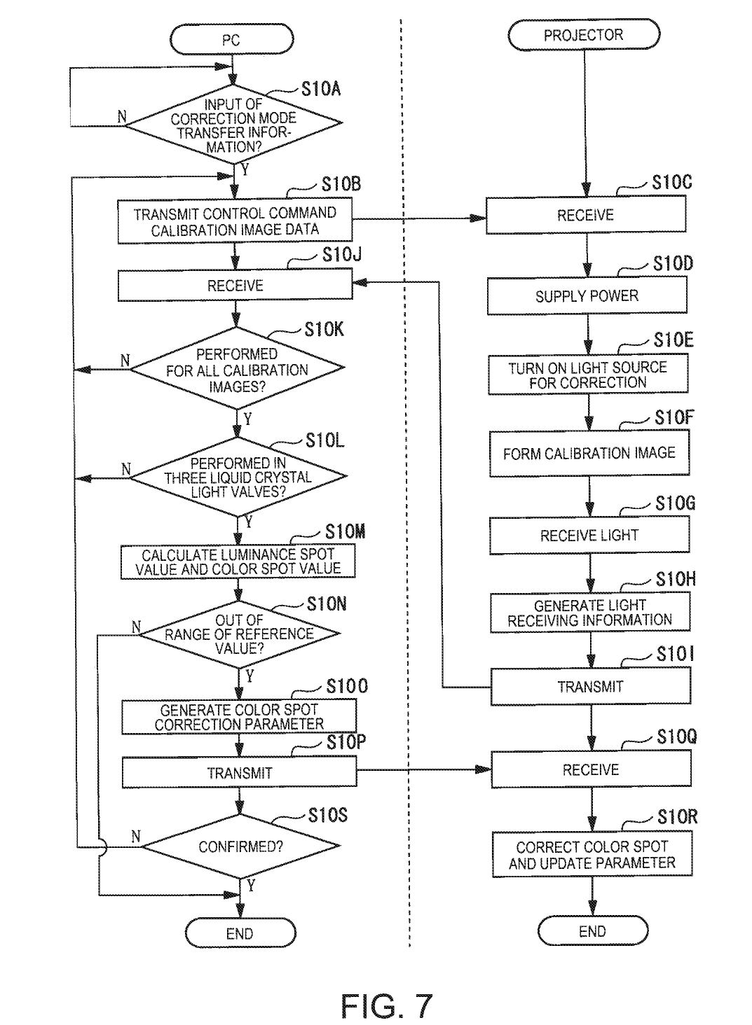

FIG. 7 is a flow chart illustrating an operation of the projection system 1.

In the following description, an operation of the projection system 1 in the correction mode will be mainly described, and an operation of the projection system 1 in the projection mode will be omitted.

In addition, it is assumed that the components of the projection system are preset as described below.

That is, the light source 315 for correction is installed inside the housing 311.

In addition, the lens cover 312 is attached to the circumference of the opening 3111 of the housing 311.

In addition, the PC 2 is connected to the projector 3 via the USB cable 4. That is, the power generating part 32 of the projector 3 supplies the driving voltage based on the power, which is supplied from the PC 2 via the USB cable 4, to the controller 33.

The display controller 2363 of the PC 2 counts driving time of the projector 3 (driving time of the liquid crystal light valves 3144) by means of a timer or the like, and, after the counted driving time reaches preset time, displays information indicating update of the color spot correction parameters on the displaying part 22 to urge a user to transfer to the correction mode.

In addition, the mode transferring part 2361 of the PC 2 always monitors whether or not the mode transfer information indicating the transfer to the correction mode is inputted and set when the menu 22A is operated through the operating part 21 (Step S10A).

If it is determined at Step S10A that the mode transfer information indicating the transfer to the correction mode is inputted and set (“Y”), the mode transferring part 2361 transmits a predetermined control command and a calibration image data to the projector 3 (Step S10B).

After the Step S10B, the controller 33 of the projector 3 receives the control command and the calibration image data transmitted from the PC 2 (Step S10C).

After the Step S10C, the power controller 3331 drives the power generating part 32 according to the control command transmitted from the PC 2, generates a driving voltage based on power supplied from the PC 2 via the USB cable 4, and supplies the generated driving voltage to the light receiving elements 313, the light source 315 for correction, and the controller 33 (Step S10D).

After the Step S10D, the controller body 333 drives the light source 315 for correction according to the control command transmitted from the PC 2, and controls the LED module 315G to emit G color light (Step S10E).

After the Step S10E, the controller body 333 acquires the calibration image data transmitted from the PC 2. Then, the controller body 333 outputs a predetermined control command to the liquid crystal panel driving controller 3333. The liquid crystal panel driving controller 3333 performs a color spot correction process for the calibration image data using color spot correction parameters stored in the correction parameter storing part 3322 for internal processing, and forms an optical image based on the corrected calibration image data (calibration image) on the liquid crystal light valve 3144G for G color light (Step S10F).

After the Step S10F, the controller body 333 drives light receiving elements 313, which are arranged at positions according to pixels or pixel regions having particular gray scales (except a gray scale of 0) in the calibration image data transmitted from the PC 2, of the plurality of light receiving elements 313, and controls the light receiving elements 313 to receive an optical image which is outputted from the light source 315 for correction and-passes through the liquid crystal light valve 3144C for G color light, the cross dichroic prism 3145, and the projection lens 3146 (Step S10G). Then, the light receiving elements 313 output a light receiving signal according to the amount of received light to the controller 33.

After the Step S10G, the light receiving information generating part 3332 generates light receiving information related to the amount of received light (brightness) and the positions of the light receiving elements 313 (positions corresponding to pixels or pixel regions) based on the light receiving signal outputted from the light receiving elements 313 (Step S10H), and transmits the generated light receiving information to the PC 2 (Step S10I).

After the Step S10I, the controller body 236 of the PC 2 receives the light receiving information transmitted from the projector 3 (Step S10J). Then, the controller body 236 stores the received light receiving information in the main memory 232 or the like, for example.

After the Step S10J, the controller body 236 transmits all the calibration image data stored in the calibration image storing part 237 and determines whether or not the light receiving information for the light (G color light) through the liquid crystal light valve 3144G for G color light corresponding to all, the calibration image data is all received (Step S10K).

If it is determined at the Step S10K that the light receiving information for the G color light corresponding to all the calibration image data is not all received (“N”), the controller body 236 returns to the Step S10B where other calibration image data are transmitted to the projector 3, and the projector 3 performs the above-described Steps S10C to S10I to receive other light receiving information for the G color light. That is, the controller body 236 repeats the Steps S10B to S10J until all the light receiving information for the G color light corresponding to all the calibration image data are received.

If it is determined at the Step S10K that the light receiving information for the G color light corresponding to all the calibration image data is all received (“Y”), the controller body 236 determines whether or not the light receiving information for the light (R and B color light) through the liquid crystal light valves 3144R and 3144B for R and B color light other than G color light is all received (Step S10L).

If it is determined at the Step S10L that the light receiving information for the R and B color light corresponding to all the calibration image data is not all received (“N”), the controller body 236 returns to the Step S10B. Then, the controller body 236 transmits a control command to drive the LED module 315R, a control command to form a calibration image on the liquid crystal light valve 3144R for R color light, etc., and controls the projector 3 to perform the Steps S10C to S10I, as described above, to receive light receiving information for the R color light. Then, the controller body 236 repeats the Steps S10B to S10J until all the light receiving information for the R color light corresponding to all the calibration image data are received. Similarly, the controller body 236 repeats the Steps S10B to S10J until all the light receiving information for the B color light corresponding to all the calibration image data are received.

If it is determined at the Step S10L that the light receiving information for the R, G and B color light corresponding to all the calibration image data is all received (“Y”), the controller body 236 outputs a predetermined control command to the image processing part 235. Then, the color spot value calculating part 2356 calculates a luminance spot value P and a color spot value S over all pixels or all pixel regions, as shown in (B) and (C) of FIGS. 3, based on all the light receiving information For the R, G and B color light corresponding to all the calibration image data stored in the main memory 232 or the like, for example (Step S10M).

After the Step S10M, the color spot value determining part 2362 compares the calculated luminance spot value P or the calculated color spot value S with a reference value stored in the main memory 232 or the like, and determines whether or not the luminance spot value P or the color spot value S falls within a range of the reference value (Step S10N).

If the color spot value determining part 2362 determines at the Step S10N that the luminance spot value P or the color spot value S falls within the range of the reference value (“N”), that is, there occurs no luminance spot or no color spot, the correction mode is ended. In this case, information indicating that there occurs no luminance spot or no color spot may be displayed on the displaying part 2 to allow a user to view the information.

If the color spot value determining part 2362 determines at the Step S10N that the luminance spot value P or the color spot value S does not fall within the range of the reference value (“Y”), that is, there occurs any luminance spot or color spot, the color spot correction parameter generating part 2355 generates color spot correction parameters used for the liquid crystal light valves 3144R, 3144G and 3144B, as shown in (B) and (C) of FIGS. 3 based on all the light receiving information for the R, G and B color light corresponding to all the calibration image data stored in the main memory 232 or the like, for example (Step S10O).

After the Step S10O, the controller body 236 transmits the color spot correction parameters to the projector 3 (Step S10P).

After the Step S10P, the controller 33 of the projector 3 receives the color spot correction parameters transmitted from the PC 2 (Step S10Q).

After the Step S10Q, the controller body 333 updates the color spot correction parameters stored in the correction parameter storing part 3322 for internal processing with the received color spot correction parameters (Step S10R).

After the Step S10R, the controller body 236 of the PC 2 generates color spot correction parameters and controls the projector 3 to update the generated color spot correction parameters, and then determines whether or not the updated color spot correction parameters are confirmed to be proper parameters (Step S10S).

If the controller body 236 determines at the Step S10S that tile updated color spot correction parameters are not confirmed to be proper parameters (“N”), the controller body returns to the Step S10B where the above-described Steps S10B to S10N are performed. In this case, at the Step S10F, a color spot correction process is performed for the calibration image data using the updated color spot correction parameters and an optical image is formed based on the corrected calibration image data. Then, it is determined at the Step S10N whether or not the luminance spot values P or the color spot values S fall outside the range of the reference value to confirm whether or not the updated color spot correction parameters are proper parameters. That is, if it is determined that the luminance spot values P or the color spot values S do not fall within the range of the reference value, the updated color spot correction parameters are confirmed not to be proper parameters. Accordingly, at the Step S10O, color spot correction parameters are generated and the projector 3 updates the generated color spot correction parameters. On the other hand, if it is determined that the luminance spot values P or the color spot values S fall within the range of the reference value, the correction mode is ended.

The above-described first embodiment has the following effects.

In the projector 3, since the plurality of light receiving elements 313 are installed at the lens cover 312, when the lens cover 312 is attached to the circumference of the opening 3111 in the correction mode, the optical image can be directly received in the plurality of light receiving elements 313 via the liquid crystal light valves 3144, the cross dichroic prism 3145 and the projection lens 3146. Accordingly, in the correction mode, it is convenient for a user since the user need not install the screen Sc or the projector. In addition, since the color spot correction parameter generating part 2355 generates the color spot correction parameters based on the light receiving information including the light receiving signal according to the amount of light inputted to and outputted from the plurality of light receiving elements 313, it can properly generate the color spot correction parameters without depending on installation environments of the projector 3.

Accordingly, the color spot correction parameters to correct color spots occurring in a projection image can be properly corrected without projecting an image onto the screen Sc, and moreover, luminance spots and color spots occurring in the projection image with elapsed time of optical devices, such as the liquid crystal light valves 3144, can be properly corrected using the color spot correction parameters.

In addition, the projector 3 including the correction parameter storing part 3322 for internal processing and the image correction calculating part 3333B performs the color spot correction process. Accordingly, since the color spot correction process can be performed at the last phase in the projector 3, an image correction process can be even quickly performed, compared to an color spot correction process in the PC 2.

Here, since the projector 3 uses the light source 315 for correction for emitting the correction light to the liquid crystal light valves 3144, based on the amount of light received in the plurality of light receiving elements 313, in he correction mode, separately from the light source 3141A, the PC 2 can generate the color spot correction parameters properly based on the light receiving information including the light receiving signal according to the amount of light outputted from the plurality of light receiving elements 313. In addition, since the light source 315 for correction includes the LED modules 315R, 315G and 315B with low intensity of illumination and low power consumption, power consumption can be reduced in the correction mode.

In addition, in the projector 3, the power generating part 32 generates the driving voltage based on the power from the PC 2 via the USB cable 4 in the correction mode, and supplies the generated driving voltage to the light receiving elements 313, the light source 315 for correction, and the controller 33, which operate in the correction mode. Accordingly, in the correction mode, the projector 3 can be driven based on the power outputted from the PC 2 via the USB cable 4, and thus, there is no need to connect the projector 3 to an external power supply via the AC cable 5. Accordingly, only by connecting the projector 3 to the PC 2 via the USB cable 4, the color spot correction parameters can be generated in the correction mode, thereby giving a user convenience more.

In addition, in this embodiment, since the light receiving elements 313 are employed as a light detecting part, costs of the projector 3 can be further reduced, for example, compared to when imaging devices are employed as the light detecting part.

In addition, since the light receiving elements 313 are attached to the lens cover 312, there is no need to arrange the light receiving elements 313 in an optical path from the light source 3141A, through the liquid crystal light valves 3144, to the projection lens 3146, thereby achieving a simplified structure of the projector 3. In addition, since the lens cover 312 is detachably attached to the opening 3111, when the lens cover 312 is detached from the opening 3111 in the normal projection mode and the lens cover 312 is attached to the opening 3111 in the correction mode, the optical image that is outputted from the liquid crystal light valves 3144 and passes through the projection lens 3146 can be detected in the light receiving elements 313. Accordingly, the lights receiving elements 313 can be arranged depending on a use mode of the projector 3, thereby giving a user convenience more.

### Second Embodiment

Next, a second embodiment of the invention will be described with reference to the drawings.

In the second embodiment, the same elements as the firs embodiment are denoted by the same reference numerals, and explanation thereof will be omitted.

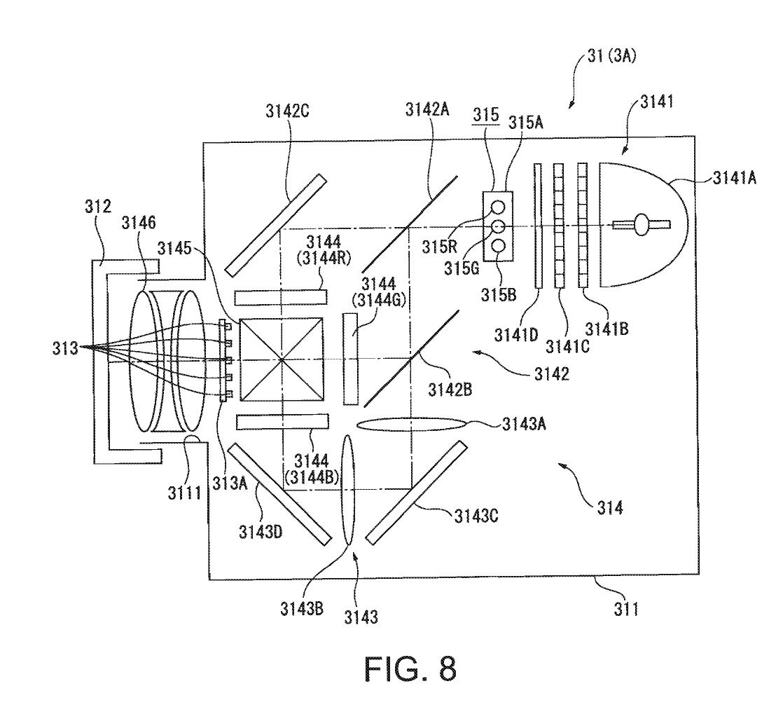

FIG. 8 is a schematic plan view showing an optical system of a projector 3A according to the second embodiment.

In the projector 3 according to the first embodiment, the plurality of light receiving elements 313 is arranged at the lens cover 312. That is, the plurality of light receiving elements 313 is arranged at a rear stage of an optical path of the projection lens 3146.

In the projector 3A according to the second embodiment, the plurality of light receiving elements 313 are arranged in an insertion member 313A that is detachably arranged in an optical path of the optical unit 314 inside the housing 311, as shown in FIG. 8. Specifically, the insertion member 313A is detachably arranged between the cross dichroic prism 3145 and the projection lens 3146, as shown in FIG. 8. When the insertion member 313A is installed inside the housing 311, the plurality of light receiving elements 313 is electrically connected to the controller 33, receives an optical image outputted via the cross dichroic prism 3145, and outputs a light receiving signal based on the amount of received light (brightness) to the controller 33.

In addition, the position of light receiving elements 313 relative to the insertion member 313A and the number of light receiving elements 313 are not particularly limited as long as they can receive at least a portion of the optical image via the cross dichroic prism 3145.

Except that the plurality of light receiving elements 313 is arranged in the insertion member 313A, the projection system 1 (including the PC 2, the projector 3A and the USB cable 4) is the same configuration and operation as the first embodiment, and therefore, explanation thereof will be omitted.

The above-described second embodiment has substantially the same operation and effect as the first embodiment although the former has changed position of the plurality of light receiving elements 313.

### Third Embodiment

Next, a third embodiment of the invention will be described with reference to the drawings.

In the third embodiment, the same elements as the first and second embodiments are denoted by the same reference numerals, and explanation thereof will be omitted.

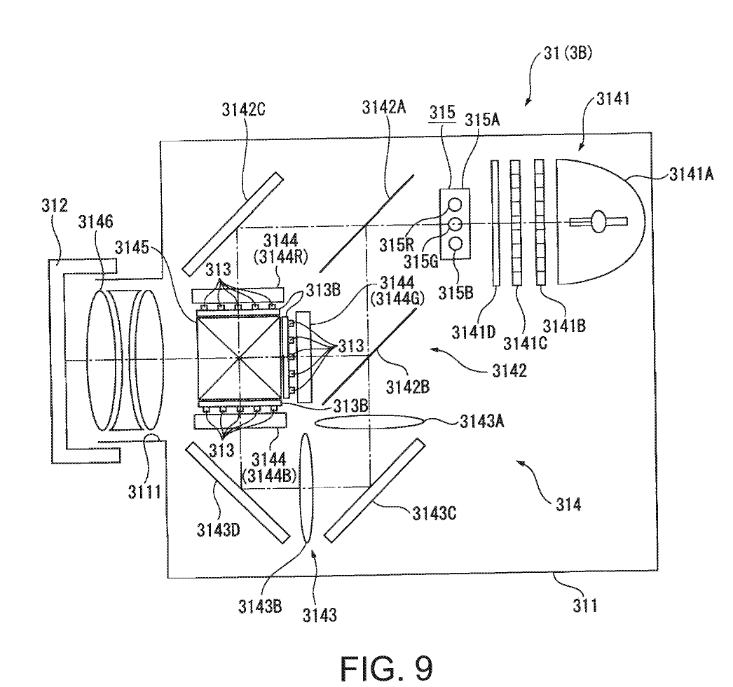

FIG. 9 is a schematic plan view showing an optical system of a projector 3B according to the third embodiment.

In the projector 3 according to the first embodiment, the plurality of light receiving elements 313 is arranged at the lens cover 312, and receives an optical image via the liquid crystal light valves 3144.

In the projector 3B according to the third embodiment, the plurality of light receiving elements 313 is arranged in three insertion members 313B that are detachably arranged in an optical path of the optical unit 314 inside the housing 311, as shown in FIG. 9. Specifically, the three insertion members 313B are detachably arranged between three light incident-side sections of the cross dichroic prism 3145 and the liquid crystal light valves 3144, respectively, as shown in FIG. 9. When the insertion members 313B are installed inside the housing 311, the plurality of light receiving elements 313 arranged in the insertion members 313B is electrically connected to the controller 33, receives an optical image outputted via the liquid crystal light valves 3144, and outputs a light receiving signal based on the amount of received light (brightness) to the controller 33.

In addition, the position of light receiving elements 313 relative to the insertion members 313B and the number of light receiving elements 313 are not particularly limited as long as they can receive at least a portion of the optical image via the liquid crystal light valves 3144.

Except that the plurality of light receiving elements 313 is arranged in the three insertion members 313B, respectively, the projection system 1 (including the PC 2, the projector 3B and the USB cable 4) is the same configuration and operation as the first embodiment, and therefore, explanation thereof will be omitted.

The above-described third embodiment has substantially the same operation and effect as the first embodiment although the former has changed position of the plurality of light receiving elements 313.

In addition, since optical images outputted from three light crystal light valves 3144 are received in different light receiving elements 313, light receiving information for R, G and B color light can be collectively generated without driving the LED modules 315R, 315G and 315B, that is, the liquid crystal light valves 3144R, 3144G and 3144B, in order in the correction mode, as in the first embodiment. Accordingly, color spot correction parameters can be quickly generated and updated in the correction mode.

### Fourth Embodiment

Next, a fourth embodiment of the invention will be described with reference to the drawings.

In the fourth embodiment, the same elements as the first, second and third embodiments are denoted by the same reference numerals, and explanation thereof will be omitted.

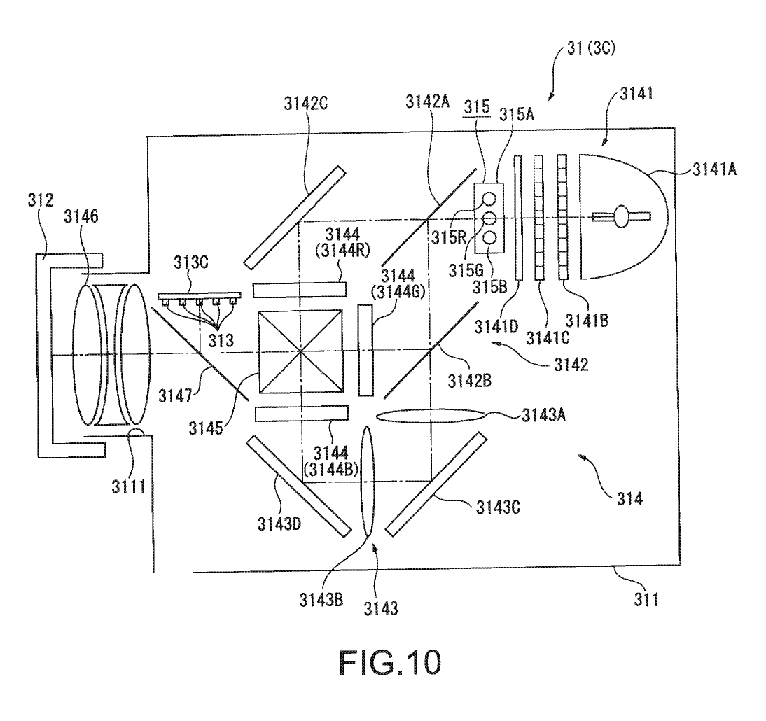

FIG. 10 is a schematic plan view showing an optical system of a projector 3C according to the fourth embodiment.

In the projector 3 according to the first embodiment, the plurality of light receiving elements 313 is arranged at the lens cover 312. That is, the plurality of light receiving elements 313 is detachably arranged in the projector 3.

In the projector 3C according to the fourth embodiment, the plurality of light receiving elements 313 are arranged in a fixation member 313C that is fixedly arranged inside the housing 311, as shown in FIG. 10. That is, the plurality of light receiving elements 313 is built in the projector 3C. In the fourth embodiment, a half mirror 3147 inclined by about 45° with respect to an optical axis is disposed between the cross dichroic prism 3145 and the projection lens 3146, as shown in FIG. 10. For example, when the half mirror 3147 has relatively high transmittance (for example, 95% or so), it may be built in the projector 3C, like the fixation member 313C. In addition, instead of building the half mirror 3147 in the projector 3C, the half-mirror 3147 may be detachably arranged inside the housing 311. In addition, the fixation member 313C is arranged to face a reflection surface of the half mirror 3147. The plurality of light receiving elements 313 arranged in the fixation member 313C receives an optical image outputted via the cross dichroic prism 3145 and reflected by the half mirror 3147, and outputs a light receiving signal based on the amount of received light (brightness) to the controller 33.

In addition, the position of light receiving elements 313 relative to the fixation member 313C and the number of light receiving elements 313 are not particularly limited as long as they can receive at least a portion of the optical image reflected by the half mirror 3147.

Except that the plurality of light receiving elements 313 is arranged in the fixation member 313C and the half mirror 3147 is provided in the housing 311, the projection system 1 (including the PC 2, the projector 3C and the USB cable 4) has the same configuration and operation as the first embodiment, and therefore, explanation thereof will be omitted.

The above-described fourth embodiment has substantially the same operation and effect as the first embodiment although the former has changed position of the plurality of light receiving elements 313.

In addition, the plurality of light receiving elements 313 can be built in the projector 3C by means of the fixation member 313C and the half mirror 3147, and accordingly, there is no need to install the lens cover 312 at which the plurality of light receiving elements 313 is arranged in the correction mode, as in the first embodiment, thereby giving a user convenience more.

### Fifth Embodiment

Next, a fifth embodiment of the invention will be described with reference to the drawings.

In the fifth embodiment, the same elements as the first to fourth embodiments are denoted by the same reference numerals, and explanation thereof will be omitted.

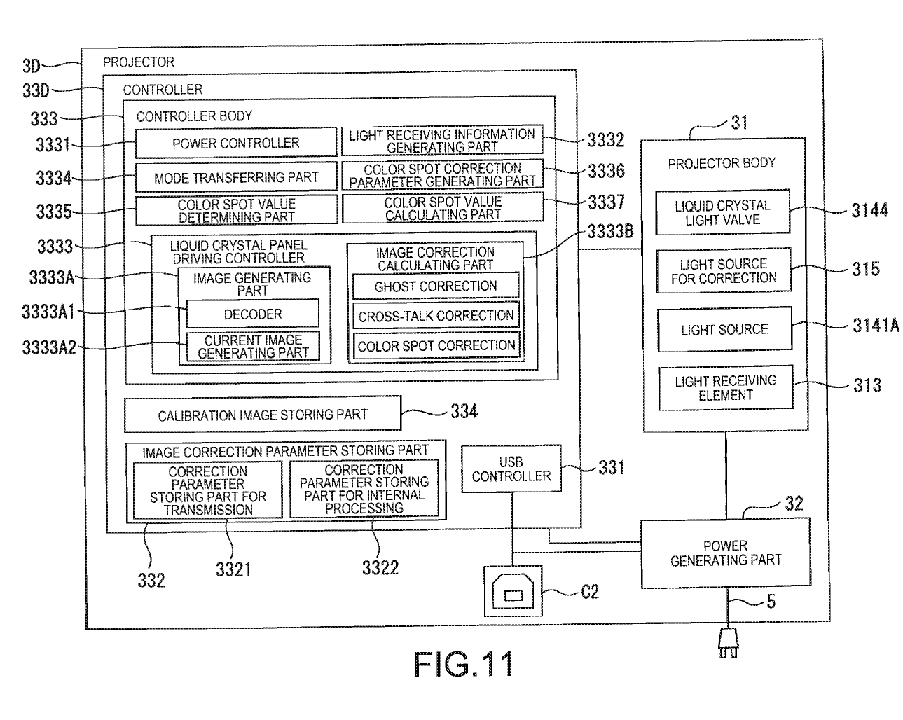

FIG. 11 is a block diagram showing a general configuration of a projector 3D according to the fifth embodiment.

In the first embodiment, the PC 2 performs the processes of transfer to the projection and correction modes, storage of the calibration image data, calculation and determination of luminance spot values P and color spot values S, and generation of color spot correction parameters.

In the fifth embodiment, conversely, the projector 3D performs the processes of transfer to the projection and correction modes, storage of the calibration image data, calculation and determination of luminance spot values P and color spot values S, and generation of color spot correction parameters. In addition, as shown in FIG. 11, unlike the controller 33 of the projector 3 of the first embodiment, a controller 33D of the projector 3D includes a calibration image storing part 334, a mode transferring part 3334, a color spot value determining part 3335, a color spot correction parameter generating part 3336, and a color spot value calculating part 3337, which correspond to the calibration image storing part 237, the mode transferring part 2361, the color spot value determining part 2362, the color spot correction parameter generating part 2355, and the color spot value calculating part 2356 described in the first embodiment. In addition, although not shown in the figure, the PC 2 does not include the calibration image storing part 237, the mode transferring part 2361, the color spot value determining part 2362, the color spot correction parameter generating part 2355, and the color spot value calculating part 2356.

Here, the mode transferring part 3334 transfers to the projection mode or the correction mode when an operating panel (not shown) provided in the projector 3D is operated to input and set mode transfer information indicating transfer to the projection mode and transfer to the correction mode. In addition, the mode transferring part 3334 outputs a control command to various components.

In addition, in the fifth embodiment, the power controller 3331 drives the power generating part 32 according to a control command from the mode transferring part 3334, as described below.

For example, the power controller 3331 drives the power generating part 32 according to a control command to transfer to the projection mode, which is transmitted from the mode transferring part 3334, generates a driving voltage based on power supplied via the AC cable 5, and supplies the generated driving voltage to the light source 3141A and the controller 33D.

In addition, for example, the power controller 3331 drives the power generating part 32 according to a control command to transfer to the correction mode, which is transmitted from the mode transferring part 33345 generates a driving voltage based on power supplied via the AC cable 5, and supplies the generated driving voltage to the light receiving elements 313, the light source 315 for correction, and the controller 33D.

Next, an operation of the above-described projector 3D will be described with reference to the drawings.

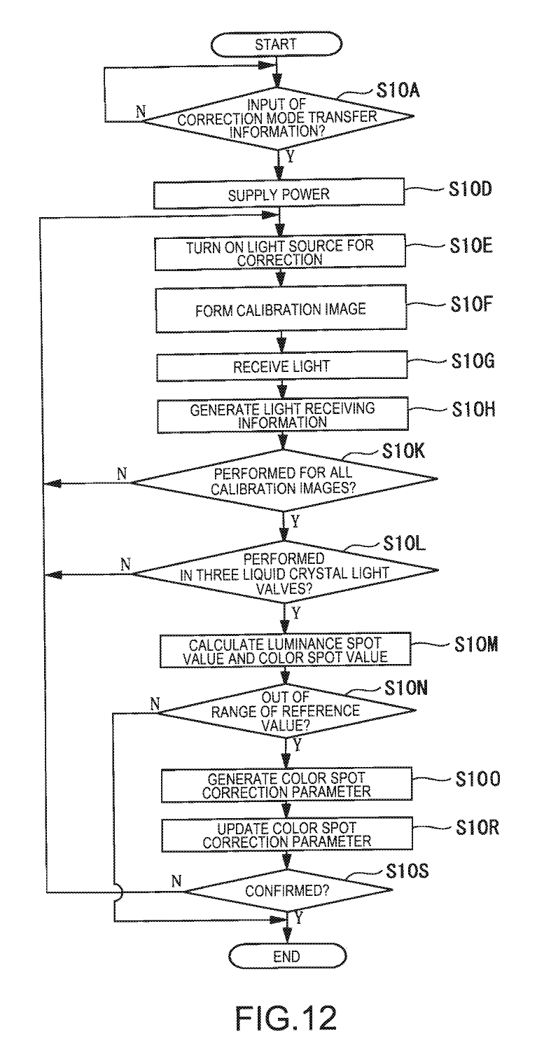

FIG. 12 is a flow chart illustrating an operation of the projector 3D according to the fifth embodiment.

In the following description, an operation of the projector 3D in the correction mode will be mainly described, and an operation of the projector 3D in the projection mode will be omitted.

In addition, as described above, since the projector 3D has some of functions of the PC 2 in the fifth embodiment, the projector 3D in the correction mode is substantially the same operation as the projection system 1 in the correction mode, which was described in the first embodiment. Therefore, in the following description, the operations substantially same as in the correction mode of the projection system 1 of the first embodiment are denoted by the same reference numerals, and explanation of which will be simplified.

In addition, it is assumed that the components of the projector 3D are preset as described below.

That is, the light source 315 for correction is installed inside the housing 311.

In addition, the lens cover 312 is attached to the circumference of the opening 3111 of the housing 311.

In addition, the projector 3D is connected to a plug socket (not shown) via the AC cable 5. That is, the power generating part 32 supplies a driving voltage based on power, which is supplied from an external power supply via the AC cable 5, to the controller 33D.

In addition, the PC 2 is not connected to the projector 3D via the USE cable 4.

First, the mode transferring part 3334 always monitors whether or not the mode transfer information indication the transfer to the correction mode is inputted and set through the operating panel (Step S10A).

If it is determined at Step S10A that the mode transfer information indicating the transfer to the correction mode is inputted and set (“Y”), the mode transferring part 3334 outputs a predetermined control command to various components of the projector 3D.

After the Step S10A, the power controller 3331 drives the power generating part 32 according to the control command from the mode transferring part 3334, generates a driving voltage based on power supplied via the AC cable 5, and supplies the generated driving voltage to the light receiving elements 313, the light source 315 for correction, and the controller 33D (Step S10D).

After the Step S10D, the LED module 315G of the light source 315 for correction is driven and turned on according to the control command from the mode transferring part 3334 (Step S10E).

After the Step S10E, the liquid crystal panel driving controller 3333 performs a color spot correction process for the calibration image data stored in the calibration image storing part 334 using color spot correction parameters stored in the correction parameter storing part 3322 for internal processing, according to the control command from the mode transferring part 3334, and forms an optical image based on the corrected calibration image data (calibration image) on the liquid crystal light valve 3144G (Step S10F).

After the Step S10F, light receiving elements 313, which are arranged at positions according to pixels or pixel regions having particular gray scales (except a gray scale of 0) in the calibration image data, of the plurality of light receiving elements 313 receive an optical image via the liquid crystal light valve 3144G for G color light, the cross dichroic prism 3145, and the projection lens 3146, according to the control command from the mode transferring part 3334 (Step S10G). Then, the light receiving elements 313 output a light receiving signal according to the amount of received light to the controller 33D.

After the Step S10G, the light receiving information generating part 3332 receives the light receiving signal outputted from the light receiving elements 313 and generates light receiving information (Step S10H). Then, the light receiving information generating part 3332 stores the generated light receiving information in a memory not shown).

After the Step S10H, the controller body 333 determines whether or not the light receiving information for the light (G color light) through the liquid crystal light valve 3144G for G color light corresponding to all the calibration image data is all generated (Step S10K).

If it is determined at the Step S10K that the light receiving information for the G color light corresponding to all the calibration image data is not all received (“N”), the controller body 333 returns to the Step S10E where an optical image based on other calibration image data is formed in the liquid crystal light valves 3144, and the optical image is received in the light receiving elements 313 to generate light receiving information. That is, the controller body 333 repeats the Steps S10E to S10H until all the light receiving information for the G color light corresponding to all the calibration image data is generated.

If it is determined at the Step S10K that the light receiving information for the G color light corresponding to all the calibration image data is all generated (“Y”), the controller body 333 determines whether or not the light receiving information for the light (R and B color light) through the liquid crystal light valves 3144R and 3144B for R and B color light other than G color light is all generated (Step S10L).

If it is determined at the Step S10L that the light receiving information for the R and B color light corresponding to all the calibration image data is not all generated (“N”), the controller body 333 returns to the Step S10B. Then, the controller body 333 outputs a control command to drive the LED module 315R, a control command to form a calibration image on the liquid crystal light valve 3144R for R color light, etc., and controls the projector 3D to perform the Steps S10E to S10H, as described above, to generate light receiving information for the R color light. Then, the controller body 333 repeats the Steps S10E to S10H until all the light receiving information for the R color light corresponding to all the calibration image data is generated. Similarly, the controller body 333 repeats the Steps S10E to S10H until all the light receiving information for the B color light corresponding to all the calibration image data is generated.

If it is determined at the Step S10L that the light receiving information for the R, G and B color light corresponding to all the calibration image data is all generated (“Y”), the color spot value calculating part 3337 calculates a luminance spot value P and a color spot value S over all pixels or all pixel regions, based on all the light receiving information for the R, G and B color light corresponding to all the calibration image data stored in a memory (not shown) (Step S10M).

After the Step S10M, the color spot value determining part 3335 compares the calculated luminance spot value P or the calculated color spot value S with a reference value stored in the memory (not shown), and determines whether or not the luminance spot value P or the color spot value S falls within a range of the reference value (Step S10N).

If the color spot value determining part 3335 determines at the Step S10N that the luminance spot value P or the color spot value S falls within the range of the reference value (“N”), that is, there occurs no luminance spot or no color spot, the correction mode is ended.

If the color soot value determining part 3335 determines at the Step S10N that the luminance spot value P or the color spot value S does not fall within the range of the reference value (“Y”), that is, there occurs any luminance spot or color spot, the color spot correction parameter generating part 3336 generates color spot correction parameters used for the liquid crystal light valves 3144R, 3144G and 3144B, based on all the light receiving information for the R, G and B color light corresponding to all the calibration image data stored in the memory (not shown) (Step S10O).

After the Step S10O, the color spot correction parameter generating part 3336 updates the color spot correction parameters stored in the correction parameter storing part 3322 for internal processing with the generated color spot correction parameters (Step S10R).

After the Step S10R, the controller body 333 determines whether or not the updated color spot correction parameters are confirmed to be proper parameters (Step S10S).

If the controller body 333 determines at the Step S10S that the updated color spot correction parameters are not confirmed to be proper parameters (“N”), the controller body 333 returns to the Step S10E where the above-described Steps S10E to S10H and S10K to S10N are performed. In this case at the Step S10F, a color spot correction process is performed for the calibration image data using the updated color spot correction parameters and an optical image is formed based on the corrected calibration image data. Then, it is determined at the Step S10N whether or not the luminance spot values P or the color spot values S fall outside the range of the reference value to confirm whether or not the updated color spot correction parameters are proper parameters. That is, if it is determined that the luminance spot values P or the color spot values S fall outside the range of the reference value, the updated color spot correction parameters are confirmed not to be proper parameters. Accordingly, at the Step S10O, color spot correction parameters are generated and the projector 3D updates the updated color spot correction parameters. On the other hand, if it is determined that the luminance spot values P or the color spot values S fall within the range of the reference value, the correction mode is ended.

The above-described fifth embodiment has the following effects in addition to the effects of the first embodiment.

Since the projector 3D includes the calibration image storing part 334, the mode transferring part 3334, the color spot value determining part 3335, the color spot correction parameter generating part 3336, and the color spot value calculating part 3337, the projector 3D can generate the color spot correction parameters. Accordingly, the color spot correction parameters can be generated without connecting the projector 3D to the PC 2 via the USB cable 4, thereby giving a user convenience more.

In addition, the invention is not limited to the above-described embodiments, but includes modifications, changes and improvements without departing from the spirit and scope of the invention.

In the above embodiments the color spot correction parameter generating parts 2355 and 3336 are employed as a parameter correcting part. That is, although it is configured that the parameter correcting part generates new color spot correction parameters, the invention is not limited to this. For example, it may be configured that the parameter correcting part generates correction information for correcting current color spot correction parameters and updates the color spot correction parameters stored in the correction parameter storing part 3322 for internal processing based on the generated correction information.

In the above embodiments, although the light receiving elements 313 such as photodiodes are employed as a light detecting part, the invention is not limited to this. For example, an imaging device such as a CCD or a MOS sensor may be employed as the light detecting part.

In the above embodiments, although the projector performs the color spot correction process for the image information based on the color spot correction parameters, the invention is not limited to this. For example, it may be configured that the PC performs the color spot correction process. Specifically, in the first to fourth embodiments, the correction parameter storing part 3322 for internal processing and the image correction calculating part 3333B may be excluded from the projectors 3, 3A, 3B and 3C, and parts corresponding to these parts 3322 and 3333B may be added to the PC 2. With this configuration, the PC 2 performs substantially all the image processes for the image information (processes of resolution conversion, contour emphasis, black/white expansion, color conversion, γ correction, VT-γ correction, shape conversion, ghost correction, cross-talk correction, color spot correction, etc.).

In the above first to fourth embodiments, although it is configured that the mode transferring information is inputted and set through the operating part 21 of the PC 2, the invention is not limited to this. For example, it may be configured that the mode transferring information is inputted and set through an operation panel (not shown) of the projectors 3, 3A, 3B and 3C, and the mode transferring part 2361 of the PC 2 transfers to the projection mode or the correction mode based on the inputted and set mode transferring information.

In the above embodiments, although the PC 2 performs the image processes or resolution conversion, contour emphasis, black/white expansion, color conversion, γ correction, VT-γ correction and shape conversion, and the projector 3 performs the image process of ghost correction, cross-talk correction and color spot correction, the invention is not limited to this. For example, it may be configured that the PC 2 performs all the image processes or the projector 3 performs all the image processes.

In addition, the configuration and arrangement position of the light source 315 for correction are not limited to the above embodiments. For example, the configuration and arrangement position of the light source 315 for correction may be as follows.

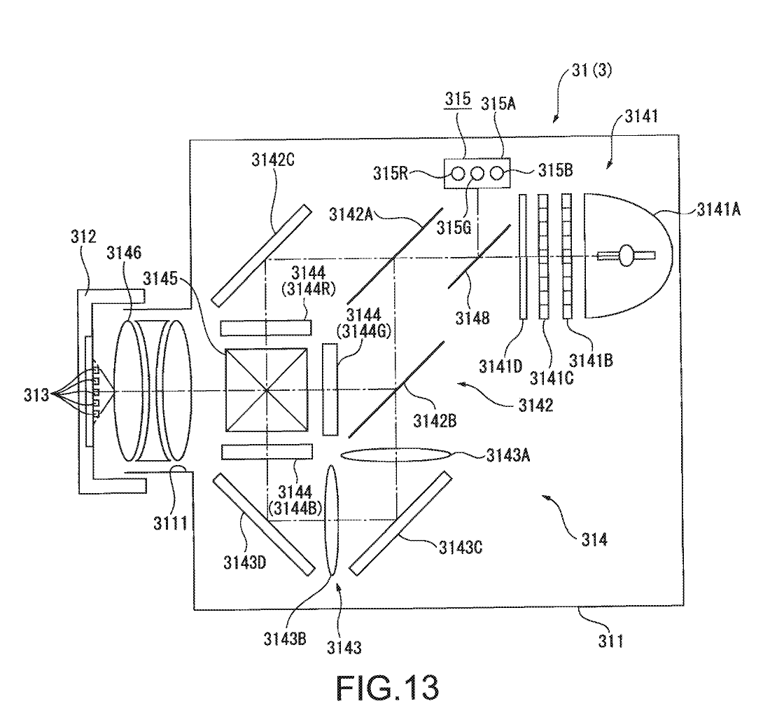

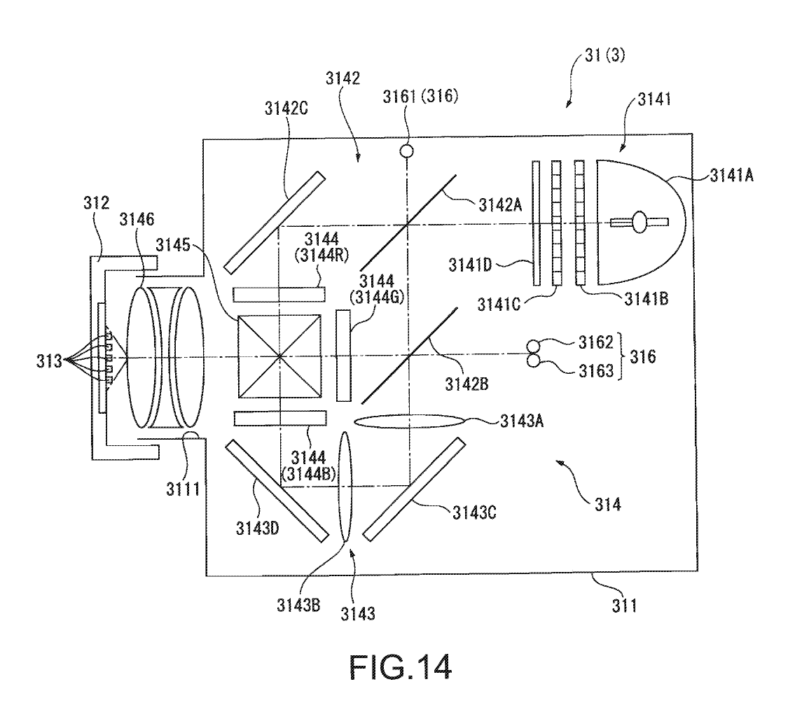

FIGS. 13 and 14 are views showing a modification of each of the above embodiments, particularly showing different configurations and arrangement positions of the light source 315 for correction.

For example, as shown in FIG. 13, a half mirror 3148 inclined by about 45° with respect to an optical axis is disposed between a polarization converting element 3141D and a dichroic mirror 3142A. The half mirror 3148 may have the configuration and operation as the half mirror 3147 of the fourth embodiment. In addition, the half mirror 3148 may be either built in the projector 3 or detachably arranged inside the housing 311. In addition, the light source 315 for correction is arranged to face a reflection surface of the half mirror 3148. In this case, like the half mirror 3148, the Light source 315 for correction may be either built in the projector 3 or detachably arranged inside the housing 311.

In addition, although the above-described configuration is illustrated with the first embodiment, it may be applied to the second to fifth embodiments.

In addition, for example, as shown in FIG. 14, a light source 316 for correction is constituted by a first LED module 3161, a second LED module 3162 and a third LED module 3163, which are disposed separately from each, other.

More specifically, the first LED module 3161 is an LED module for emitting green or blue color light, and is disposed to be out of an optical axis from the light source 3141A to the liquid crystal light valves 3144 and face the dichroic mirror 3142A, as shown in FIG. 14. The green or blue color light emitted from the first LED module 3161 is reflected by the dichroic mirror 3142A, reflected again by the reflection mirror 3142C, and then irradiated on the liquid crystal light valve 3144R for red color light.

The second LED module 3162 is an LED module for emitting blue color light, and is disposed to be out of an optical axis from the light source 3141A to the liquid crystal light valves 3144 and face the dichroic mirror 3142B, as shown in FIG. 14. The blue color light emitted from the second LED module 3162 passes through the dichroic mirror 3142B and then is irradiated on the liquid crystal light valve 3144G for green color light.

The third LED module 3163 is an LED module for emitting red or green color light, and is disposed near the second LED module 3162, as shown in FIG. 14. The red or green color light emitted from the third LED module 3163 is reflected by the dichroic mirror 3142B, passes through the relay optical system 3143, and then is irradiated on the liquid crystal light valve 3144B for blue color light.

As described above, it may be configured that the light source for correction irradiates different color light on the liquid crystal light valves 3144, respectively (for example, irradiates the green or blue color light on the liquid crystal light valve 3144R for red color light).

In addition, like the light source 315 for correction described in the above embodiments, the light source 316 for correction is not limited to the LED modules, but may include other light emitting devices. In addition, the light source 316 for correction may be either built in the projector 3 or detachably arranged inside the housing 311.

In addition, although the above-described configuration is illustrated with the first embodiment, it may be applied to the second to fifth embodiments.

In the above embodiments and the modifications shown in FIGS. 13 and 14, although it is configured that the projectors 3, 3A, 3B, 3C and 3D include the light sources 315 and 316 for correction, the invention is not limited to this, but the light sources 315 and 316 may be omitted. For example, in the first embodiment, a light source driving controller to drive the light source 3141A is provided in the controller body 333. The light source driving controller reduces a voltage applied to the light source 3141A in the correction mode, that is, reduces the amount of light emitted from the light source 3141A and outputs the reduced amount of light to the liquid crystal light valves 3144. With this configuration, there is no need to provide the light sources 315 and 316 for correction, thereby achieving low costs of the projector 3. In addition, although the above-described configuration is illustrated with the first embodiment, it may be applied to the second to fifth embodiments.

In the above embodiments, although the USB cable 4 is employed as information transferring means, the invention is not limited to this it is preferable that the information transferring means allows power as well as information to be supplied. The information transferring means may employ, for example, IEEE1394 standards, PoE (Power over Ethernet: registered as a trademark) standards, etc.

In the above embodiments, it may be configured that the protectors 3, 3A, 3B, 3C and 3D inform a user of information indicating that the color spot correction parameters are updated, and urge the user to transfer to the correction mode. It may be configured that the user is informed of the information by means of voice or LEDs, without being particularly limited.

In the fifth embodiment, although the PC 2 does not include the calibration image storing part 237, the mode transferring part 2361, the color spot value determining part 2362, the color spot correction parameter generating part 2355, and the color spot value calculating part 2356, and the projector 3D includes the calibration image storing part 334, the mode transferring part 3334, the color spot value determining part 3335, the color spot correction parameter generating part 3336, and the color spot value calculating part 3337, the invention is not limited to this. For example, the projector may perform all the processes for display of an image. That is, in the fifth embodiment, the projector 3D may further include the sub memory 233 and the image processing part 235 of the PC 2. With this configuration, since the projector 3D includes all of functions of displaying the image, the projector 3D alone can perform a process of displaying an image source in the sub memory 233, without connecting the PC 2 to the projector 3D via the USB cable 4, thereby giving a user convenience more.

In the above embodiments, although the liquid crystal panel (the liquid crystal light valves 3144) is of a transmission type, the invention is not limited to this, but the liquid crystal panel may be a reflection type or may employ Digital Micro-mirror Device (registered as a trademark of Texas Instruments company).

In the above embodiments, although the number of liquid crystal light valves 3144 is three, the invention is not limited to this, but the number of liquid crystal light valves 3144 may be one, two, or four or more.

Although a front-typed projector to project light from a direction in which a screen is viewed is illustrated in the above embodiments, the invention may be applied to a rear-typed projector to project light from a side opposite the direction in which the screen is viewed.

As apparent from the above description, since color spot correction parameters to correct color spots occurring in a projection image can be properly corrected without projecting an image on a screen, the invention is useful for a projection system employing a projector used for a presentation or a home theater.

The present invention is not limited to the above-described exemplary embodiments, but may be properly changed in various ways without departing from the scope and spirit of the invention when read throughout the annexed claims and the specification.

It should be understood by those skilled in the art that various modifications, combinations, sub-combinations and alterations may be occur depending on design requirements and other factors insofar as they are within the scope of the appended claims or the equivalents thereof.

The entire disclosure of Japanese Patent Application No. 2005-360161, filed Dec. 14, 2005 is expressly incorporated by reference herein.

What is claimed is:

1. A projection system comprising:
an information processing apparatus that processes image information;
a projector including a light source, an optical modulation device that modulates light emitted from the light source based on the image information processed by the information processing apparatus and forms an optical image, and a projection optical apparatus that enlarges and projects the optical image to form a projection image; and
an information transferring unit that interconnects the information processing apparatus and the projector for information exchange between the information processing apparatus and the projector,
wherein the projector includes a light detecting part that is disposed at a rear side of an optical path of the optical modulation device, detects at least a portion of the optical image outputted from the optical modulation device, and outputs detection information, and
wherein the information processing apparatus includes:
a correction mode transferring part that transfers to a correction mode in which a predetermined optical image is formed by the optical modulation device and at least a portion of the optical image is detected in the light detecting part to correct a color spot correction parameter for correcting color spots occurring in the projection image; and
a parameter correcting part that acquires the detection information outputted from the light detecting part via the information transferring unit and corrects the color spot correction parameter based on the acquired detection information in the correction mode.

2. The projection system according to claim 1, wherein the projector further includes:
a correction parameter storing part that stores the color spot correction parameter; and
a color spot correcting part that performs a color spot correction process to correct the color spots occurring in the projection image for the image information processed in the information processing apparatus, based on the color spot correction parameter stored in the correction parameter storing part, and
wherein the parameter correcting part updates the color spot correction parameter stored in the correction parameter storing part with the corrected color spot correction parameter.

3. The projection system according to claim 1, wherein the projector further includes a light source for correction that emits correction light to correct the color spot correction parameter to the optical modulation device in the correction mode.

4. The projection system according to claim 1, wherein the projector further includes a light source driving controller that drives the light source, changes the amount of light emitted from the light source, and emits the changed amount of light to the optical modulation device in the correction mode.

5. The projection system according to claim 1, wherein the information transferring unit includes a power transmission line that supplies power from a power supply of the information processing apparatus to the projector, and
wherein the projector further includes a power generating part that supplies a driving voltage to internal components of the projector in the correction mode, based on the power supplied via the power transmission line.

6. The projection system according to claim 1, wherein the light detecting part includes a light receiving element that receives at least a portion of the optical image outputted from the optical modulation device and outputs a light receiving signal based on the amount of received light.

7. A projector including a light source, an optical modulation device that modulates light emitted from the light source based on image information and forms an optical image, and a projection optical apparatus that enlarges and projects the optical image to form a projection image, comprising:
a light detecting part that is disposed at a rear side of an optical path of the optical modulation device, detects at least a portion of the optical image outputted from the optical modulation device, and outputs detection information;
a correction parameter storing part that stores the color spot correction parameter to correct color spots occurring in the projection image; and
a color spot correcting part that performs a color spot correction process to correct the color spots occurring in the projection image for the image information processed in the information processing apparatus, based on the color spot correction parameter stored in the correction parameter storing part,
wherein, in a correction mode in which a predetermined optical image is formed by the optical modulation device and at least a portion of the optical image is detected in the light detecting part to correct the color spot correction parameter, the correction parameter storing part updates the stored color spot correction parameter with the corrected color spot correction parameter based on the detection information outputted from the light detecting part.

8. The projector according to claim 7, further comprising:
a correction mode transferring part that transfers to a correction mode in which a predetermined optical image is formed by the optical modulation device and at least a portion of the optical image is detected in the light detecting part to correct a color spot correction parameter for correcting color spots occurring in the projection image; and
a parameter correcting part that corrects the color spot correction parameter based on the detection information outputted from the light detecting part and updates the color spot correction parameter stored in the correction parameter storing part with the corrected color spot correction parameter in the correction mode.

9. The projector according to claim 7, further comprising a light source or correction that emits correction light to correct the color spot correction parameter to the optical modulation device in the correction mode.

10. The projector according to claim 7, further comprising a light source driving controller that drives the light source, changes the amount of light emitted from the light source, and emits the changed amount of light to the optical modulation device in the correction mode.

11. The projector according to claim 7, further comprising:
an information transferring unit including a power transmission line that supplies power from a power supply of an information processing apparatus to the projector; and
a power generating part that supplies a driving-voltage to internal components of the projector in the correction mode, based on the power supplied via the power transmission line.

12. The projector according to claim 7, wherein the light detecting part includes a light receiving element that receives at least a portion of the optical image outputted from the optical modulation device and outputs a light receiving signal based on the amount of received light.

13. The projector according to claim 7, further comprising a housing that accommodates the light source, the optical modulation device and the projection optical apparatus,
wherein the housing includes an opening through which light projecting from the projection optical apparatus passes,
wherein a covering member is detachably arranged at the opening such that the opening can be closed/opened, and
wherein the light detecting part is attached to the covering member, detects at least a portion of the optical image that is outputted from the optical modulation device and passes through the projection optical apparatus, and outputs detection information.

14. The projector according to claim 7, wherein the optical modulation device is provided in plural numbers,
the projector further comprising:
a color composition optical device that mixes optical images formed in the plurality of optical modulation devices; and
a housing that accommodates the light source, the plurality of optical modulation devices, the color composition optical device, and the projection optical apparatus,
wherein an insertion member is disposed between the color composition optical device and the projection optical apparatus, and
wherein the light detecting part is attached to the insertion member, detects at least a portion of the optical images that are outputted from the optical modulation device and pass through the color composition optical device, and outputs detection information.

15. The projector according to claim 7, wherein the optical modulation device is provided in plural numbers,
the projector further comprising:
a color composition optical device that mixes optical images formed in the plurality of optical modulation devices; and
a housing that accommodates the light source, the plurality of optical modulation devices, the color composition optical device, and the projection optical apparatus,
wherein a plurality of insertion members is disposed between the plurality of optical modulation devices and the color composition optical device, and
wherein the light detecting part is attached to each of the plurality of insertion members, detects at least a portion of the optical image that is outputted from each of the optical modulation devices, and outputs detection information.
